(19) United States
(12) Patent Application Publication
(10) Pub. No.: US 2025/0293246 A1
(43) Pub. Date: Sep. 18, 2025

(54) METHOD OF MANUFACTURING ELECTRODE FOR ELECTROCHEMICAL ELEMENT, ELECTRODE FOR ELECTROCHEMICAL ELEMENT, ELECTRODE LAMINATE FOR ELECTROCHEMICAL ELEMENT, ELECTROCHEMICAL ELEMENT, AND ALL SOLID STATE ELECTROCHEMICAL ELEMENT

(71) Applicants: Hiroto SUZUKI, Kanagawa (JP); Shun GOTO, Tokyo (JP); Ryuji HIGASHI, Kanagawa (JP); Yukihiro IMANAGA, Tokyo (JP); Hitoshi KIDA, Kanagawa (JP); Tomomasa KAJITA, Kanagawa (JP)

(72) Inventors: Hiroto SUZUKI, Kanagawa (JP); Shun GOTO, Tokyo (JP); Ryuji HIGASHI, Kanagawa (JP); Yukihiro IMANAGA, Tokyo (JP); Hitoshi KIDA, Kanagawa (JP); Tomomasa KAJITA, Kanagawa (JP)

(21) Appl. No.: 19/080,981

(22) Filed: Mar. 17, 2025

(30) Foreign Application Priority Data
Mar. 18, 2024 (JP) 2024-042550

(51) Int. Cl. H01M 4/36; H01M 4/02; H01M 4/62

(52) U.S. Cl. CPC H01M 4/366; H01M 4/622; H01M 2004/021

(57) ABSTRACT

A method of manufacturing an electrode for an electrochemical element includes forming a structured layer including applying a first liquid composition containing a first polymerizable compound and a first solvent onto a substrate, polymerizing the first liquid composition applied in the applying the first liquid composition to form a first polymerized compound layer of the first liquid composition with a porous structure, and applying a second liquid composition containing a second polymerizable compound and a second solvent onto the first polymerized compound layer to manufacture the electrode that includes the substrate, an electrode composite layer disposed on the substrate, and the structured layer disposed on at least a part of an outer periphery of the electrode composite layer.

### CROSS-REFERENCE TO RELATED APPLICATION

This patent application is based on and claims priority pursuant to 35 U.S.C. § 119 to Japanese Patent Application Nos. 2024-042550, filed on Mar. 18, 2024, in the Japan Patent Office, the entire disclosure of which is hereby incorporated by reference herein.

### BACKGROUND

### Technical Field

The present disclosure is related to a method of manufacturing an electrode for electrochemical element, an electrode for an electrochemical element, an electrode laminate for an electrochemical element, an electrochemical element, and an all solid state electrochemical element.

### Description of the Related Art

All solid state secondary batteries are expected to see increased demand, such as installation in electric vehicles, not only due to their safety features, such as higher resistance to temperature changes and reduced risk of fire compared to typical lithium-ion secondary batteries, but also due to their performance features, such as the ability to support rapid charging. In addition, the demand for thin batteries for applications such as wearable devices and medical patches is increasing, leading to diversification in the requirements for all solid state secondary batteries.

In all solid state batteries formed of a positive electrode, a negative electrode, and a solid electrolyte layer, the laminated body including the positive electrode, the solid electrolyte layer, and the negative electrode is sometimes pressed at extremely high pressure to achieve high density, thereby improving the performance of the all solid state battery. However, damage such as cracks occurring in the solid electrolyte during this pressing process may lead to short circuits between the positive and negative electrodes. To address this issue, technologies to prevent such damage have been proposed.

### SUMMARY

According to embodiments of the present disclosure, a method of manufacturing an electrode for an electrochemical element is provided which includes forming a structured layer including applying a first liquid composition containing a first polymerizable compound and a first solvent onto a substrate, polymerizing the first liquid composition applied in the applying the first liquid composition to form a first polymerized compound layer of the first liquid composition with a porous structure, and applying a second liquid composition containing a second polymerizable compound and a second solvent onto the first polymerized compound layer to manufacture the electrode that includes the substrate, an electrode composite layer disposed on the substrate, and the structured layer disposed on at least a part of an outer periphery of the electrode composite layer.

As another aspect of embodiments of the present disclosure, an electrode for an electrochemical element is provided which includes a substrate, an electrode composite layer disposed on the substrate, and a structured layer disposed on at least a part of an outer periphery of the electrode composite layer, wherein the structured layer comprises a laminar structure of at least two layers including a first structured layer primarily in contact with the substrate and a second structured layer disposed on the first structured layer.

As another aspect of embodiments of the present disclosure, an electrode for an electrochemical element is provided which includes a substrate and a structured layer having a porous structure disposed on at least a part of the substrate, wherein the structured layer has a laminar structure of at least two layers including a first structured layer primarily in contact with the substrate and a second structured layer disposed on the first structured layer and the second structured layer has a porosity greater than a porosity of the first structured layer.

As another aspect of embodiments of the present disclosure, an electrode laminate for an electrochemical element is provided which includes the electrode mentioned above, and a solid electrolyte layer disposed on the electrode composite layer and the structured layer.

As another aspect of embodiments of the present disclosure, an electrochemical element is provided which includes the electrode mentioned above.

As another aspect of embodiments of the present disclosure, all solid state electrochemical element is provided which includes the electrode laminate mentioned above.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1A is a schematic diagram illustrating a cross-sectional view of an electrode for an electrochemical element obtained by executing the method of manufacturing an electrode for an electrochemical element relating to an embodiment of the present disclosure;

FIG. 1B is a schematic diagram illustrating a cross-sectional view of an electrode for an electrochemical element obtained by executing the method of manufacturing an electrode for an electrochemical element relating to another embodiment of the present disclosure;

FIG. 2A is a schematic diagram illustrating a cross-sectional view of an electrode for an electrochemical element according to an embodiment of the present disclosure;

FIG. 2B is a schematic diagram illustrating a cross-sectional view of an electrode for an electrochemical element according to another embodiment of the present disclosure;

FIG. 2C is a schematic diagram illustrating a cross-sectional view of an electrode for an electrochemical element according to another embodiment of the present disclosure;

FIG. 3A is a schematic diagram illustrating a top view of an electrode for an electrochemical element according to an embodiment of the present disclosure;

FIG. 3B is a schematic diagram illustrating a top view of an electrode for an electrochemical element according to another embodiment of the present disclosure;

FIG. 3C is a schematic diagram illustrating a top view of an electrode for an electrochemical element according to another embodiment of the present disclosure;

FIG. 3D is a schematic diagram illustrating a top view of an electrode for an electrochemical element according to another embodiment of the present disclosure;

FIG. 3E is a schematic diagram illustrating a top view of an electrode for an electrochemical element according to another embodiment of the present disclosure;

FIG. 3F is a schematic diagram illustrating a top view of an electrode for an electrochemical element according to another embodiment of the present disclosure;

FIG. 3G is a schematic diagram illustrating a top view of an electrode for an electrochemical element according to another embodiment of the present disclosure;

FIG. 3H is a schematic diagram illustrating a top view of an electrode for an electrochemical element according to another embodiment of the present disclosure;

FIG. 3I is a schematic diagram illustrating a top view of an electrode for an electrochemical element according to another embodiment of the present disclosure;

FIG. 4 is a schematic diagram illustrating the method of manufacturing an electrode for an electrochemical element according to an embodiment of the present disclosure;

FIG. 5 is a schematic diagram illustrating the device (liquid discharging device) for manufacturing an electrode for an electrochemical element according to an embodiment of the present disclosure;

FIG. 6 is a schematic diagram illustrating the device (liquid discharging device) for manufacturing an electrode for an electrochemical element according to another embodiment of the present disclosure;

FIG. 7 is a schematic diagram illustrating a variation of the device for manufacturing an electrode for an electrochemical element according to an embodiment of the present disclosure;

FIG. 8 is a diagram (part 1) illustrating a configuration of an example of the printing unit employing an inkjet method and transfer method as the liquid composition applying device in a device for manufacturing a member for an electrochemical element according to an embodiment of the present disclosure;

FIG. 9 is a diagram (part 2) illustrating a configuration of an example of the printing unit employing an inkjet method and transfer method as the device for applying the first liquid composition and the device for forming a second polymerized compound layer of the second liquid composition in the device for manufacturing an electrode for an electrochemical element according to an embodiment of the present disclosure;

FIG. 10 is a schematic diagram illustrating a cross-sectional view of an electrode laminate for an electrochemical element according to an embodiment of the present disclosure;

FIG. 11 is a schematic diagram illustrating a cross-sectional view of the all solid state electrochemical element according to an embodiment of the present disclosure;

FIG. 12 is a schematic diagram illustrating a cross-sectional view of the all solid state electrochemical element according to an embodiment of the present disclosure;

FIG. 13 is a schematic diagram illustrating a mobile object, which is an electrochemical element according to an embodiment of the present disclosure;

FIG. 14 is a conceptual diagram illustrating an example of the method of evaluating the spreading; and

FIG. 15 is a conceptual diagram illustrating an example of the method of evaluating the flatness.

The accompanying drawings are intended to depict example embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a method of manufacturing an electrode for an electrochemical element is provided which can minimize the uncontrolled spreading of the liquid compositions on the substrate.

For example, as a technique for partially coating an electrode for an electrochemical element, a method has been proposed in Japanese Patent No. 4730038 to form an insulating layer composed of an insulating resin film around the electrode tab of a lithium-ion battery to impart corrosion resistance and adhesive properties.

In typical electrode manufacturing, including the method disclosed in Japanese Patent No. 4730038 mentioned above, the insulating layer (insulating resin film) is available from applying an insulating layer forming liquid composition onto a substrate (e.g., an electrode substrate). Generally, due to variations in the substrate's surface condition—arising not only from differences in metal types but also from manufacturing processes, production lots, and other conditions—the spreading of the insulating layer forming liquid composition cannot be sufficiently controlled, making uniform film formation challenging.

The method of manufacturing an electrode for an electrochemical element according to the present disclosure is capable of fully addressing the various issues found in typical techniques. The electrode for an electrochemical element obtained by the method of the present disclosure has a laminar structure including at least two or more layers, including the first polymerized compound layer of a first liquid composition and the second polymerized compound layer of a second liquid composition. The first polymerized compound layer of the first liquid composition serves as a surface modifier for the substrate and minimizes the uncontrolled spreading of the subsequently applied second liquid composition. In other words, the method achieves the production of an electrode for an electrochemical element capable of minimizing the uncontrolled spreading of the liquid composition on the substrate.

The present disclosure is described in detail below.

Method of Manufacturing Electrode for Electrochemical Element and Apparatus for Manufacturing Electrode for Electrochemical Element

The method of manufacturing an electrode for an electrochemical element according to the present disclosure includes structured layer formation and may optionally include other processes.

The apparatus for manufacturing an electrode for an electrochemical element according to the present disclosure includes a structured layer forming device and may optionally include other devices.

The method for manufacturing an electrode for an electrochemical element can be suitably carried out using the apparatus for manufacturing an electrode for an electrochemical element.

In the present specification, the “first liquid composition” and the “second liquid composition” may simply be referred to as “liquid composition.”

### Structured Layer Formation and Structured Layer Forming Device

The structured layer formation is to form a structured layer and includes applying a first liquid composition (application of a first liquid composition or first liquid composition application), polymerizing the first liquid composition (polymerized compound layer formation of the first liquid composition) to form the first polymerized compound layer of the first liquid composition, and applying a second liquid composition (application of a second liquid composition or second liquid composition application).

Optionally, it may further include forming the second polymerized compound layer of the second liquid composition and drying the polymerized compound layer of the liquid compositions.

The structured layer forming device is to form the structured layer and includes a first liquid composition application device, a polymerized compound layer forming device for forming the first polymerized compound layer of the first liquid composition, and a second liquid composition application device for forming the second polymerized compound layer of the second liquid composition. Optionally, it may further include a polymerized compound layer forming device for forming the second polymerized compound layer of the second liquid composition and a device for drying the polymerized compound layer of the liquid compositions.

The structured layer formation can be suitably carried out using the structured layer forming device.

In the present specification, the “first polymerized compound layer of the first liquid composition” and the “second polymerized compound layer of the second liquid composition” may be referred to as the “polymerized compound layer of the liquid composition.”

### First Liquid Composition Application and Device for Applying First Liquid Composition

The first liquid composition application is to apply a first liquid composition containing a first polymerizable compound and a first solvent onto a substrate.

The device for applying the first liquid composition is to apply the first liquid composition containing the first polymerizable compound and the first solvent onto a substrate.

The first liquid composition application can be suitably carried out by the device for applying the first liquid composition.

The first liquid composition application and the device for applying the first liquid composition are not particularly limited and can be suitably selected to suit to a particular application.

Examples include, but are not limited to, spin coating, casting, microgravure coating, gravure coating, bar coating, roll coating, wire bar coating, dip coating, slit coating, capillary coating, spray coating, nozzle coating, gravure printing, screen printing, flexographic printing, offset printing, reverse printing, and inkjet printing. Among these, from the perspective of accurately applying the first liquid composition to a desired location, the inkjet method (technique) is preferred.

### Substrate

The substrate is not particularly limited as long as it has electronic conductivity and is stable with respect to the applied potential. It can be appropriately selected according to a particular application. Examples include, but are not limited to, aluminum foil, copper foil, stainless steel foil, titanium foil, conductive polymers, etched foil with fine holes created by etching such foil, carbon-coated foil with a surface layer coated with a carbon-containing resin layer, and perforated substrates used in lithium-ion capacitors.

There are no particular restrictions on the average thickness of the substrate, and it can be appropriately selected according to a particular application. From the viewpoint of suppressing battery capacity degradation and ensuring strength, it is preferably between 1 μm and 50 μm.

As the substrate, a substrate with a pre-formed electrode composite material layer containing an active material may be used.

For the substrate with a pre-formed electrode composite material layer containing an active material, it is preferable that, in the first liquid composition application, the first liquid composition is applied onto the substrate and the outer periphery of the electrode composite material layer.

### First Liquid Composition

The first liquid composition contains a first polymerizable compound and a first solvent, and may optionally furthermore contain a polymerization initiator and other components.

The first liquid composition forms a polymerized compound layer of the first liquid composition that has a porous structure-a porous polymerized compound layer. In other words, through the polymerization and curing of the first polymerizable compound in the first liquid composition, a polymerized compound layer with a porous structure (referred to as a “porous structure body,” “resin structure body,” or “porous resin”) having a resin framework is formed.

The phrase “forms a polymerized compound layer of the first liquid composition having a porous structure” not only refers to cases where the porous structure is formed within the first liquid composition, but also includes cases where a precursor of the porous structure (e.g., the skeletal part of the porous resin) is formed in the first liquid composition and subsequently undergoes additional treatment (e.g., heat treatment) to form the polymerized compound layer of the first liquid composition having a porous structure.

### Other Polymerizable Compound

The first polymerizable compound refers to a compound that forms polymers upon application of heat, light, electromagnetic wave, and other stimuli.

As the first polymerizable compound, a compound having a polymerizable functional group with a double bond is preferred because it has a fast polymerization rate, reduces the generation of by-products that adversely affect the properties of electrochemical elements, and minimizes the occurrence of undesired reactions involving functional groups when used in an electrochemical element. Among such compounds, those having multiple acrylic functional groups are more preferred.

From the perspective of minimizing curling that may occur during the curing of the first liquid composition, the first polymerizable compound is preferably a compound represented by Chemical Formula 1 or Chemical Formula 2, having multiple units of monosubstituted ethylene, 1,1-disubstituted ethylene, 1,2-disubstituted ethylene, and/or diene compounds that are capable of conducting radical polymerization.

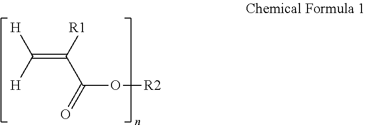

In Chemical Formula 1, R1 represents a hydrogen atom or a methyl group, R2 represents a hydrocarbon chain, an alkylene oxide chain, a polyester chain, or an acrylic oligomer ester derivative, and n represents an integer of from 2 to 6.

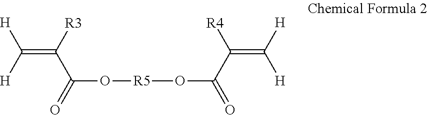

In Chemical Formula 2, R3 and R4 each, independently, represent hydrogen atoms or methyl groups.

n in Chemical Formula 1 is preferably 2 or 3, and more preferably 2 to reduce curling that occurs during the curing of the first liquid composition.

To achieve a superior curl development reduction effect, it is preferable that the first liquid composition contains a polymerizable compound in which R2 in Chemical Formula 1 is a polyester chain, or a polymerizable compound represented by Chemical Formula 2. It is more preferable that the first liquid composition contain a first polymerizable compound in which R2 in Chemical Formula 1 is a polycaprolactone chain.

As for the first polymerizable compound, from the perspective of polymerization rate, it preferably has an acrylic group, that is, R1 in Chemical Formula 1 and R3 and R4 in Chemical Formula 2 are preferably hydrogen atoms.

In general, acrylic groups have high radical polymerizability, allowing for the rapid formation of cured products by using a photopolymerization initiator or a thermal polymerization initiator in combination in the first liquid composition. Cured products can be obtained without the use of polymerization initiators. However, in the case of a polymerizable compound with an acrylic group (i.e., R1 in Chemical Formula 1 and R3 and R4 in Chemical Formula 2 are hydrogen atoms), it is preferable from the perspective of polymerization rate and equipment cost to use the first polymerizable compound in combination with a thermal polymerization initiator or a photopolymerization initiator in the first liquid composition, and it is even more preferable to use the first polymerizable compound in combination with a photopolymerization initiator.

Specific examples of the polymerizable compounds include, but are not limited to, difunctional alkyl acrylates, hydroxy pivalic acid neopentyl glycol acrylate adducts, difunctional polyethylene glycol acrylates, difunctional polypropylene glycol acrylates, difunctional polytetramethylene glycol acrylates, difunctional cyclic acrylates, difunctional alkoxylated aromatic acrylates, difunctional acrylic acid polymer ester acrylates, difunctional caprolactam-modified acrylates, trifunctional trimethylolpropane acrylates, trifunctional alkoxylated glycerin acrylates, trifunctional isocyanate acrylates, tetrafunctional pentaerythritol acrylates, tetrafunctional ditrimethylolpropane acrylates, tetrafunctional diglycerin tetraacrylates, hexafunctional dipentaerythritol hexaacrylates, and polyester acrylates.

Among these, from the perspective of suppressing volumetric shrinkage, difunctional alkyl acrylate, difunctional polyethylene glycol acrylate, difunctional alkoxylated aromatic acrylate, difunctional acrylate oligomer ester acrylate, trifunctional trimethylolpropane acrylate, trifunctional alkoxylated glycerin acrylate, and trifunctional isocyanate acrylate are preferred, with difunctional alkyl acrylate, difunctional polyethylene glycol acrylate, difunctional alkoxylated aromatic acrylate, and difunctional acrylate oligomer ester acrylate being more preferred.

Moreover, among difunctional alkyl acrylates, difunctional polyethylene glycol acrylates, difunctional alkoxylated aromatic acrylates, and difunctional acrylic acid polymer ester acrylates, difunctional polyethylene glycol acrylates, difunctional acrylic acid polymer ester acrylates, and difunctional polyester acrylates are more preferable.

Specific examples of the difunctional alkyl acrylates include, but are not limited to, those sold under the trade names NK Ester A-HD-N, A-NON-N, A-DOD-N, and A-NPG (all available from Shin-Nakamura Chemical Co., Ltd.), Light Acrylate NP-A, MPD-A, 1,6HX-A, and 1,9ND-A (all available from Kyoeisha Chemical Co., Ltd.), and KAYARAD NPGDA (available from Nippon Kayaku Co., Ltd.).

Specific examples of the hydroxy pivalic acid neopentyl glycol acrylate adducts include, but are not limited to, those sold under the trade names Light Acrylate HPP-A (available from Kyoeisha Chemical Co., Ltd.), Biscoat #195, Biscoat #230, and Biscoat #260 (all available from OSAKA ORAGANIC CHEMICAL INDUSTRY LTD.), Miramer M210 and Miramer M216 (both available from Miwon Specialty Chemical Co., Ltd.), and KAYARAD FM-400 (available from Nippon Kayaku Co., Ltd.).

Specific examples of the difunctional polyethylene glycol acrylates include, but are not limited to, those sold under the trade names NK Ester A-200, NK Ester A-400, NK Ester A-600, and NK Ester A-1000 (all available from Shin Nakamura Chemical Co., Ltd.), Light Acrylate 3EG-A, Light Acrylate 4EG-A, Light Acrylate 9EG-A, and Light Acrylate 14EG-A (all available from Kyoeisha Chemical Co., Ltd.), Brenmar ADE-200, Brenmar ADE-300, and Brenmar ADE-400A (all available from NOF Corporation), and Miramer M202 (available from Miwon Specialty Chemical Co., Ltd.).

Specific examples of the difunctional polypropylene glycol acrylates include, but are not limited to, those sold under the trade names NK Ester APG-200, NK Ester APG-400, and NK Ester APG-700 (all available from Shin Nakamura Chemical Co., Ltd.), Biscoat #310HP (available from OSAKA ORAGANIC CHEMICAL INDUSTRY LTD.), Brenmar ADP-400 (available from NOF Corporation), and Miramer M210, Miramer M216, and Miramer M220 (all available from Miwon Specialty Chemical Co., Ltd.).

Specific examples of the difunctional polytetramethylene glycol acrylates include, but are not limited to, those sold under the trade names NK Ester A-PTMG65 (available from Shin Nakamura Chemical Co., Ltd.), Light Acrylate PTMGA-250 (available from Kyoeisha Chemical Co., Ltd.), and Brenmar ADT-250 (available from NOF Corporation).

Specific examples of the difunctional cyclic acrylates include, but are not limited to, those sold under the trade names NK Ester A-DCP (available from Shin Nakamura Chemical Co., Ltd.), Light Acrylate DCP-A (available from Kyoeisha Chemical Co., Ltd.), and KAYARAD R-604 and KAYARAD R-684 (both available from Nippon Kayaku Co., Ltd.).

Specific examples of the difunctional alkoxylated aromatic acrylates include, but are not limited to, those sold under the trade names NK Ester ABE-300, A-BPE-4, A-BPE-10, and A-BPE-20 (all available from Shin Nakamura Chemical Co., Ltd.), Light Acrylate BP-4EAL, BA-134, and BP-10EA (all available from Kyoeisha Chemical Co., Ltd.), Biscoat #540(available from Osaka Organic Chemical Industry Ltd.), and KAYARAD R-551 and KAYARAD R-712 (both available from Nippon Kayaku Co., Ltd.).

A specific example of the difunctional acrylic acid polymer ester acrylate is Biscoat #230D (available from Osaka Organic Chemical Industry Ltd.).

Specific examples of the difunctional caprolactam-modified acrylates include, but are not limited to, those sold under the trade names KAYARAD HX-220 and KAYARAD HX-620 (both available from Nippon Kayaku Co., Ltd.).

Specific examples of the trifunctional trimethylolpropane acrylates include, but are not limited to, those sold under the trade names NK Ester A-TMPT, A-TMPT-9EO, and AT-20E (all available from Shin Nakamura Chemical Co., Ltd.), Light Acrylate TMP-3EO-A and Light Acrylate TMP-6EO-3A (both available from Kyoeisha Chemical Co., Ltd.), and Biscoat #295 (available from Osaka Organic Chemical Industry Ltd.).

Specific examples of the trifunctional alkoxylated glycerin acrylates include, but are not limited to, those sold under the trade names NK Ester A-GLY-3E, A-GLY-9E, and A-GLY-20E (all available from Shin Nakamura Chemical Co., Ltd.).

Specific examples of the trifunctional isocyanate acrylates include, but are not limited to, those sold under the trade names NK Ester A-9300 and A-9200YN (both available from Shin Nakamura Chemical Co., Ltd.).

Specific examples of the tetrafunctional pentaerythritol acrylates include, but are not limited to, those sold under the trade names NK Ester A-TMMT and ATM-35E (both available from Shin Nakamura Chemical Co., Ltd.) and Light Acrylate PE-3A and Light Acrylate PE-4A (both available from Kyoeisha Chemical Co., Ltd.).

A specific example of the tetrafunctional ditrimethylolpropane acrylate is NK Ester AD-TMP (available from Shin Nakamura Chemical Co., Ltd.).

One specific example of the tetrafunctional diglycerin tetraacrylate is Light Acrylate DGE-4E (available from Kyoeisha Chemical Co., Ltd.).

One specific example of the hexafunctional dipentaerythritol hexaacrylate is Light Acrylate DPE-6A (available from Kyoeisha Chemical Co., Ltd.).

Specific examples of the polyester acrylates include, but are not limited to, those sold under the trade names Aronix M-6100, Aronix M-6200, Aronix M-6250, Aronix M-6500, Aronix M-7100, Aronix M-8030, Aronix M-8060, Aronix M-8100, Aronix M-8530, Aronix M-8560, and Aronix M-9050 (all available from Toagosei Co., Ltd.), Ebecryl 81, Ebecryl 88, Ebecryl 80, Ebecryl 657, Ebecryl 1657, Ebecryl 800, Ebecryl 805, Ebecryl 808, Ebecryl 810, Ebecryl 1810, Ebecryl 450, Ebecryl 1830, Ebecryl 1870, Ebecryl 2870, Ebecryl 830, Ebecryl 835, Ebecryl 870, Ebecryl 84, and IRR 302 (all available from Daicel-Ornex Co., Ltd.), RCC13-429 (available from Sannopco Co., Ltd.), Diabeam UK-4003 and Diabeam UK-4203 (both available from Mitsubishi Chemical Corporation), CN2203, CN2270, CN2271, CN2273, and CN2274 (all available from Arkema Co., Ltd.), and KAYARAD HX-220 and KAYARAD HX-620 (both available from Nippon Kayaku Co., Ltd.).

The content of the first polymerizable compound is not particularly limited and can be appropriately selected according to a particular application. From the perspective of suppressing curing shrinkage due to polymerization while ensuring strength, it is preferably between 20 percent by mass and 70 percent by mass relative to the entire amount of the first liquid composition.

As for the first polymerizable compounds, it is preferable to contain at least one first polymerizable compound represented by Chemical Formula 1 or Chemical Formula 2. In other words, the first polymerizable compounds contained in the first liquid composition may contain only the first polymerizable compound represented by Chemical Formula 1 or Chemical Formula 2, or may contain two or more different first polymerizable compounds represented by Chemical Formula 1 or Chemical Formula 2. In either case, in addition to the first polymerizable compounds represented by Chemical Formula 1 or Chemical Formula 2, polymerizable compounds that do not meet Chemical Formula 1 or Chemical Formula 2 may also be contained.

Preferably, the first liquid composition contains no polymerizable compounds that do not meet Chemical Formula 1 or Chemical Formula 2 to minimize the deterioration of the solid electrolyte layer containing a sulfide solid electrolyte. Furthermore, the liquid composition preferably contains two or more different polymerizable compounds represented by Chemical Formula 1 or Chemical Formula 2 to expand the controllable range of the physical properties (for example, elastic modulus) of the polymerized compound layer of the first liquid composition.

### First Solvent

The first solvent is preferably an organic solvent with a water content of at most 1 percent by mass. Furthermore, if the first liquid composition is used in the production of an all solid state electrochemical element, the first solvent is preferably a low-polarity hydrophobic solvent with low reactivity toward the solid electrolyte layer.

The first solvent is expected to act as a buffer for curing shrinkage, as there is no fluctuation in intermolecular distances between solvent-solvent or resin-solvent during polymerization.

The first solvent is not particularly limited and can be suitably selected to suit to a particular application.

Specific examples include, but are not limited to, aromatic hydrocarbons such as toluene, xylene, mesitylene, anisole, and phenetole; hydrocarbon solvents such as hexane, heptane, nonane, octane, decane, menthane, cyclohexane, cyclooctane, and p-menthane; ester solvents such as ethyl butyrate, ethyl valerate, ethyl caproate, ethyl heptanoate, ethyl octanoate, ethyl nonanoate, ethyl decanoate, ethyl undecanoate, ethyl laurate, methyl butyrate, methyl valerate, methyl caproate, methyl heptanoate, methyl octanoate, methyl nonanoate, methyl decanoate, methyl undecanoate, methyl laurate, ethyl isovalerate, isoamyl acetate, isobutyl isobutyrate, 3-methoxyisobutyric acid methyl ester, butyl isobutyrate, isobutyl isovalerate, 2-methylbutyl isobutyrate, butyl isovalerate, heptyl acetate, isoamyl isovalerate, 2-ethylhexyl acetate, hexyl butyrate, ethyl benzoate, hexyl caproate, n-amyl octanoate, and hexyl acetate; and petroleum-based solvent mixtures.

Specific examples of the petroleum-based solvent mixtures include, but are not limited to, products sold under the trade names ISOPAR E, ISOPAR G, ISOPAR H, ISOPAR H BHT, ISOPAR L, ISOPAR M, EXXSOL D40, EXXSOL D80, EXXSOL D110, EXXSOL D130, EXXSOL DSP 80/100, and EXXSOL DSP 145/60 (all available from ANDOH PARACHEMIE CO., LTD.).

The first solvent preferably contains a porogen.

The porogen is liquid compatible with the polymerizable compound and becomes incompatible (i.e., causing phase separation) with the polymer (resin) in the course of polymerization of the first polymerizable compound in the first liquid composition. If the first liquid composition contains the porogen, the first polymerizable compound forms a porous structure when polymerized Moreover, it is preferable that the porogen be capable of dissolving a compound (polymerization initiator) that generates radicals or acids upon exposure to light or heat.

These can be used alone or in combination.

In the present embodiment, the solvent is not polymerizable.

The boiling point of the porogen, whether used alone or in combination with two or more types, is preferably between 50 degrees Celsius and 250 degrees Celsius under atmospheric pressure, more preferably 70 degrees Celsius and 200 degrees Celsius, and even more preferably 120 degrees Celsius and 190 degrees Celsius.

A porogen with a boiling point of at least 50 degrees Celsius is less likely to evaporate near room temperature, making the first liquid composition easier to handle and facilitating the control of its porogen content.

If the boiling point of the porogen is at most 250 degrees Celsius, the time required for its removal during the drying process of the polymerized compound layer of the first liquid composition is shortened, thereby improving the productivity of the porous polymerized compound layer of the first liquid composition. Additionally, the amount of porogen remaining inside the polymerized compound layer of the first liquid composition can be reduced. As a result, if the polymerized compound layer of the first liquid composition is used as a functional layer, such as a material separation layer for separating substances or a reaction layer serving as a reaction field, the quality of the layer is improved.

The porogen is not particularly limited and can be suitably selected to suit to a particular application.

Specific examples include, but are not limited to, ethylene glycols such as diethylene glycol monomethyl ether, ethylene glycol monobutyl ether, ethylene glycol monoisopropyl ether, and dipropylene glycol monomethyl ether, esters such as γ-butyrolactone and propylene carbonate, and an amide such as NN dimethylacetamide.

In addition, other examples include liquids having a relatively large molecular weight such as methyl tetradecanoate, methyl decanoate, methyl myristate, and tetradecane. Furthermore, liquids such as acetone, 2-ethylhexanol, and 1-bromonaphthalene can also be mentioned.

The liquid specified above is not always a porogen.

Porogens are liquids compatible with the polymerizable compound and becomes incompatible (i.e., causing phase separation) with the polymer (resin) in the course of polymerization of the first polymerizable compound in the first liquid composition. In other words, whether a liquid qualifies as a porogen is determined by its relationship with the first polymerizable compound and the polymer (resin) formed through the polymerization of the first polymerizable compound.

The first liquid composition only needs to contain at least one porogen that has a specific relationship with the first polymerizable compound. As a result, the range of materials available for the preparation of the first liquid composition is expanded, making it easier to design the first liquid composition. By broadening the range of material choices for the preparation of the first liquid composition, the composition can accommodate additional requirements other than forming a porous structure. For example, inkjetting the first liquid composition requires discharge stability. With a wider range of material options, designing the first liquid composition to meet such requirements is facilitated.

There is no particular limitation on the content of the porogen, and it can be appropriately selected depending on the purpose. It is preferable for the content of the porogen to be between 30.0 percent by mass and 95.0 percent by mass, based on the entire amount of the first liquid composition. More preferably, it is between 50.0 percent by mass and 90.0 percent by mass, and even more preferably, between 60.0 percent by mass and 80.0 percent by mass.

If the porogen content is at least 30.0 percent by mass based on the entire amount of the first liquid composition, the pore size of the resulting polymerized compound layer of the first liquid composition does not become excessively small (e.g., less than several nanometers).

This ensures that the polymerized compound layer of the first liquid composition maintains an appropriate porosity and mitigates the tendency for liquid or gas penetration to become too difficult.

If the porogen content is at most 95.0 percent by mass, a sufficiently three-dimensional network structure of the resin is formed, resulting in a porous structure. Additionally, the strength of the porous structure is improved, which is desirable.

There is no particular limitation on the content of the first solvent, and it can be appropriately selected depending on the purpose. From the perspective of curl suppression, it is preferable for the content of the first solvent to be at 30 percent by mass based on the entire amount of the first liquid composition, more preferably at least 40 percent by mass, and even more preferably at least 50 percent by mass. Additionally, the solvent content is preferably at most 70 percent by mass to control the film thickness.

The solvent in the present disclosure may be a combination of multiple solvents to increase the diversity of polymerizable compound selection.

### First Aspect of First Liquid Composition

As a first aspect of the first liquid composition, the first solvent in the first liquid composition is a solvent mixture containing both a good solvent and a poor solvent, satisfying Relationship 1, in order to minimize curl caused by volumetric shrinkage.

Polymerizable compound soluble point≤Mixing ratio X<Polymerizable compound soluble point+11 Relationship 1

In the present specification, “good solvent” refers to a solvent in which the first polymerizable compound is soluble. In the present specification, “poor solvent” refers to a solvent which leaves the first polymerizable compound undissolved. Furthermore, in the present specification, “solvent mixture” refers to a solvent that contains both good and poor solvents.

In the present specification, “mixing ratio X” refers to the percentage-based content ratio of the good solvent in a solvent mixture by mass in the solvent mixture.

In the present specification, “polymerizable compound soluble point” refers to the minimum content ratio by mass of the good solvent in a solvent mixture in which the polymerizable compound is soluble, expressed as a percentage.

The term “soluble” in the first aspect is explained below. “Soluble” refers to the property where, after mixing the first solvent and the first polymerizable compound, followed by ultrasonic stirring for 15 minutes with an ultrasonic stirrer (USS-1), no turbidity or phase separation occurs after standing for 10 minutes at a specified temperature. The specified temperature is not particularly limited as long as it is the ambient temperature during actual use. For example, it includes 25 degrees Celsius.

The determination of solubility or insolubility is made depending on the composition of the first liquid composition. For example, the following patterns 1 to 5 can be considered.

### Pattern 1

For the first liquid composition containing two types of polymerizable compounds (compound mixture) represented by Chemical Formula 1 or Chemical Formula 2 and one type of the first solvent, the solubility is determined using a mixture of 10 g of the first solvent and 1 g of the compound mixture (monomer ratio by mass in the first liquid composition).

### Pattern 2

For the first liquid composition containing one type of the first polymerizable compound represented by Chemical Formula 1 or Chemical Formula 2, one type of polymerizable compound not satisfying Chemical Formula 1 or Chemical Formula 2, and one type of first solvent, the solubility is determined using a mixture of 10 g of the first solvent and 1 g of a mixture (monomer ratio by mass in the first liquid composition) of the first polymerizable compound represented by Chemical Formula 1 or Chemical Formula 2 and a polymerizable compound not satisfying Chemical Formula 1.

### Pattern 3

For the first liquid composition containing one type of first polymerizable compound represented by Chemical Formula 1 or Chemical Formula 2 and two types of the first solvents (solvent mixture), the solubility is determined using a mixture of 10 g of the solvent mixture (monomer ratio by mass in the first liquid composition) and 1 g of the first polymerizable compound represented by Chemical Formula 1 or Chemical Formula 2.

### Pattern 4

For the first liquid composition containing two types of polymerizable compounds (compound mixture) represented by Chemical Formula 1 or Chemical Formula 2 and two types of the first solvents (solvent mixture), the solubility is determined using a mixture of 10 g of the solvent mixture and 1 g of the compound mixture (monomer ratio by mass in the first liquid composition).

### Pattern 5

For the first liquid composition containing two types of first polymerizable compounds (compound mixture) represented by Chemical Formula 1 or Chemical Formula 2, one type of polymerizable compound not satisfying Chemical Formula 1 or Chemical Formula 2, and two types of the first solvents (solvent mixtures), the solubility is determined using a mixture of 10 g of the solvent mixture (monomer ratio by mass in the first liquid composition) and 1 g of a mixture of the compound mixture and a polymerizable compound not satisfying Chemical Formula 1 or Chemical Formula 2.

Relationship 1 can also be transformed into Relationship 1′.

$$0 \leq Mixing ratio X - Polymerizable compund soluble point \leq 11 \qquad Relationship 1 ’$$

The first liquid composition of the first aspect can form a polymerized compound layer of the first liquid composition with a high porosity based on the phase separation rate under Relationship 1 or Relationship 1′. As a result, it is possible to reduce the volume shrinkage during the curing of the first liquid composition, thereby forming a high-quality polymerized compound layer of the first liquid composition.

Furthermore, as the “mixing ratio X-polymerizable compound solubility point” in Relationship 1′ approaches zero, the curling due to volume shrinkage can be further reduced.

### Second Aspect of First Liquid Composition

As a second aspect of the first liquid composition, it is preferable that the first polymerizable compound in the first liquid composition is a compound mixture containing both a soluble polymerizable compound and an insoluble polymerizable compound to reduce curling development due to volume shrinkage, and satisfies the following Relationship 2.

$$Solvent soluble point \leq Mixing ratio Y < Solvebt soluble point + 21 \qquad Relationship 2$$

In the present specification, the term “soluble polymerizable compound” refers to a polymerizable compound that is soluble in the first solvent. The term “insoluble polymerizable compound” refers to a polymerizable compound that is insoluble in the first solvent. Additionally, when the term “compound mixture” is used in the present specification, it refers to a polymerizable compound that contains both soluble and insoluble polymerizable compounds.

The term “mixing ratio Y” refers to the percentage of the mass-based content of the insoluble polymerizable compounds within the compound mixture.

The term “solvent soluble point” refers to the minimum content ratio (percentage) based on the mass of the insoluble polymerizable compounds in the compound mixture that is soluble in the first solvent.

The term “soluble” in the second aspect is explained below. “Soluble” refers to the property where, after mixing the first solvent and the first polymerizable compound, followed by ultrasonic stirring for 15 minutes with an ultrasonic stirrer (USS-1), no turbidity or phase separation occurs after standing for 10 minutes at a specified temperature. The specified temperature is not particularly limited as long as it is the ambient temperature during actual use. For example, it includes 25 degrees Celsius.

The determination of solubility or insolubility is made depending on the composition of the first liquid composition. For example, the following patterns 6 to 8 can be considered.

### Pattern 6

In the case of the first liquid composition containing one polymerizable compound represented by Chemical Formula 1 or Chemical Formula 2 and two types of the first solvents (solvent mixture), the solubility or insolubility is determined based on the monomer ratio (mass ratio) in the first liquid composition that contains 10 g of the first polymerizable compound represented by Chemical Formula 1 or Chemical Formula 2 and 1 g of the solvent mixture.

### Pattern 7

In the case of the first liquid composition containing two types of first polymerizable compounds (compound mixture) represented by Chemical Formula 1 or Chemical Formula 2 and two types of first solvents (solvent mixture), the solubility is determined based on the solvent ratio (mass ratio) in the first liquid composition that contains 10 g of the compound mixture and 1 g of the solvent mixture.

### Pattern 8

For the first liquid composition containing two types of the first polymerizable compounds (compound mixture) represented by Chemical Formula 1 or Chemical Formula 2, one type of polymerizable compound not satisfying Chemical Formula 1 or Chemical Formula 2, and two types of first solvents (solvent mixtures), the solubility or insolubility is determined based on the monomer ratio (mass ratio) of the first liquid composition containing 10 g of a mixture of the compound mixture and a polyemrizable compound not satisfying Relationship 1 or 2 and 1 g of the solvent mixture.

Relationship 2 can also be transformed into Relationship 2′.

$$0 \leq Mixing ratio Y - Solvent soluble point \leq 21 \qquad Relationship 1 ’$$

The first liquid composition of the second aspect can form a polymerized compound layer of the first liquid composition with a high porosity based on the phase separation rate under Relationship 2 or Relationship 2′. As a result, it is possible to reduce the volume shrinkage during the curing of the first liquid composition, thereby forming a high-quality polymerized compound layer of the first liquid composition.

Furthermore, as the “Mixing ratio Y—Solvent soluble point” in Relationship 2′ approaches zero, the curling development due to volume shrinkage can be further reduced.

### Polymerization Initiator

A polymerization initiator refers to a compound that undergoes cleavage by heat, light, or other stimuli to generate radicals, cations, or anions, which serve as the starting points for polymerization. Considering polymerization efficiency and other factors, ultraviolet curing initiators are preferably used. Specifically, examples include, but are not limited to, photopolymerization initiators such as alkylphenone-based polymerization initiators, acylphosphine sulfide-based polymerization initiators, and oxime ester-based polymerization initiators.

Specific examples of alkylphenone-based polymerization initiators include, but are not limited to, products such as Omnirad 651, Omnirad 184, Omnirad 1173, Omnirad 2959, Omnirad 127, Omnirad 907, Omnirad 369, Omnirad 369E, and Omnirad 379EG (all available from IGM Resins B.V.).

Specific examples of acylphosphine sulfite-based polymerization initiators include, but are not limited to, products such as Omnirad TPO and Omnirad 819 (both available from IGM Resins B.V.).

Specific examples of oxime ester-based polymerization initiators include, but are not limited to, products such as Irgacure OXE01, Irgacure OXE02, Irgacure OXE03, and Irgacure OXE04 (all available from BASF Japan).

The proportion of the polymerization initiator is not particularly limited and can be suitably selected to suit to a particular application. The content is preferably 0.05 to 10.0 percent by mass, and more preferably 0.1 to 5.0 percent by mass, of the total polymerizable compound to achieve a sufficient curing rate.

### Method of Manufacturing First Liquid Composition

There are no particular limitations on the method of manufacturing the first liquid composition, and it can be appropriately selected according to a particular application. The first liquid composition is preferably manufactured through processes such as mixing the first polymerizable compound, mixing the first polymerizable compound with the first solvent, dissolving a polymerization initiator in a solvent, and stirring to prepare a uniform solution.

### Process of Forming Polymerized Compound Layer of First Liquid Composition and Device for Forming Polymerized Compound Layer of First Liquid Composition

In the process of forming a polymerized compound layer of the first liquid composition, the first liquid composition, which has been applied in the application of the first liquid composition, is polymerized to form a polymerized compound layer of the first liquid composition.

The device for forming a polymerized compound layer of the first liquid composition is for polymerizing the first liquid composition, which has been applied in the application of the first liquid composition, to form a polymerized compound layer of the first liquid composition.

The process of forming a polymerized compound layer of the first liquid composition is suitably executed by the device for forming a polymerized compound layer of the first liquid composition.

Through the polymerized compound layer formation of the first liquid composition, the first polymerizable compound in the first liquid composition is polymerized, and a polymerized compound layer of the first liquid composition with a porous structure is formed by polymerization-induced phase separation.

As the device for forming a polymerized compound layer of the first liquid composition, there is no particular limitation as long as it can provide the energy required to advance the polymerization reaction of the first polymerizable compound. It can be appropriately selected according to a particular application, and examples include irradiation of light such as ultraviolet rays, electron beams, α-rays, β-rays, γ-rays, X-rays, and infrared rays, as well as heating. Among these, light irradiation is preferred, and ultraviolet irradiation is more preferred. The light is preferably an actinic energy ray. Such energy enables the polymerization of the first liquid composition to form the polymerized compound layer of the first liquid composition without removing the first solvent in the first liquid composition.

Note that in the case of using a particularly high-energy light source, polymerization reactions can be facilitated even without the use of a polymerization initiator.

There are no particular limitations on the irradiation intensity of the actinic energy rays, and it can be appropriately selected according to a particular application. An intensity of at most 1 W/cm² is preferable, at most 300 mW/cm² is more preferable, and at most 100 mW/cm² is even more preferable. If the irradiation intensity of the actinic energy rays is too low, excessive phase separation may occur, leading to variations and coarsening of the porous structure. Additionally, the irradiation time becomes longer, reducing productivity. Therefore, an intensity of at least 10 mW/cm² is preferable, and at least 30 mW/cm² is more preferable.

### Polymerized Compound Layer of First Liquid Composition

In the present disclosure, the polymerized compound layer of the first liquid composition has a porous structure.

The porous structure is preferably a co-continuous structure with a framework formed of a resin. The term “co-continuous structure” refers to a structure in which two or more materials or phases each have a continuous structure and do not form an interface. In the present embodiment, it refers to a structure where both the resin phase and the void phase are three-dimensional, branched, networked continuous phases. The porous structure of the present disclosure includes states in which the void phase contains a solvent or other substances. These structures can be formed through polymerization-induced phase separation (for example, see Japanese Unexamined Patent Application Publication No. 2003-1911628, WO 97/044363 A1, Japanese Unexamined Patent Application Publication No. 2005-298757, Japanese Examined Patent Application Publication No. 2010-513589, Japanese Unexamined Patent Application Publication No. 2001-163907, and Japanese Unexamined Patent Application Publication No. 2001-138504).

### Polymerization-Induced Phase Separation

Polymerization-induced phase separation refers to a state in which, before the initiation of polymerization, the first polymerizable compound and the first solvent are mutually compatible, whereas after the initiation of polymerization, the polymer (resin) formed during the polymerization and the first solvent become immiscible, resulting in phase separation. Although there are other methods of obtaining a porous structure through phase separation, the co-continuous porous structure obtained through polymerization-induced phase separation has the advantage of high resistance to chemicals and heat. Additionally, compared to other methods, it offers the benefits of a shorter process time and easier surface modification.

Next, the process of forming a porous structure using a polymerization-induced phase separation method with the first liquid composition containing the first polymerizable compound will be described.

The first polymerizable compound undergoes a polymerization reaction upon exposure to light or other stimuli, forming a resin. During this process, the solubility of the first solvent in the growing resin decreases, leading to phase separation between the resin and the first solvent. Eventually, the resin forms a co-continuous porous structure where the first solvent or other materials fill the pores, with the resin framework. Upon drying, the first solvent and other volatile components are removed, leaving behind a porous resin with a three-dimensional co-continuous structure.

Considering this polymerization-induced phase separation, the first liquid composition contains a mixture of a polymerizable compound (monomer) and a solvent, where the resin formed after polymerization is insoluble in a solvent or does not form a gel or sol.

To confirm that the polymerized compound layer of the first liquid composition has a co-continuous structure with interconnected pores, one possible method is to observe a cross-section of the polymerized compound layer using a scanning electron microscope (SEM) or similar imaging technique to verify the continuity of the pores. An example of this is presented below.

### Example of Image Observation Method Using Scanning Electron Microscopy (SEM)

The polymerized compound layer of the first liquid composition is osmium stained and then subjected to vacuum impregnation with epoxy resin. The internal cross-section structure is then cut out using a focused ion beam (FIB) and observed using a scanning electron microscope (SEM).

There are no particular restrictions on the porosity of the polymerized compound layer of the first liquid composition, and it can be appropriately selected according to a particular application. A porosity of at least 30 percent is preferred, and at least 50 percent is even more preferable. To enhance the attachability with a substrate, it is preferably at most 70 percent and more preferably at most 60 percent.

A porosity of at least 30 percent in the polymerized compound layer of the first liquid composition is preferred, as it helps to alleviate the pressure on the solid electrolyte layer from the polymerized compound layer of the first liquid composition during the pressing process after the formation of the solid electrolyte layer.

Ensuring that the porosity of the polymerized compound layer of the first liquid composition is at most 90 percent enhances its strength, making it more suitable for maintaining its shape even after the pressing process.

The porosity of the polymerized compound layer of the first liquid composition can be measured using the same method described in Example of Image Observation Method Using Scanning Electron Microscope (SEM).

There are no particular restrictions on the cross-sectional shape of the pores in the polymerized compound layer of the first liquid composition, and it can be appropriately selected according to a particular application. Examples include, but are not limited to, approximately circular, elliptical, or polygonal shapes.

The pore size refers to the length of the longest part in the cross-sectional shape of the polymerized compound layer of the first liquid composition. The pore size of the polymerized compound layer of the first liquid composition can be determined, for example, from cross-sectional images taken with a scanning electron microscope (SEM).

The size of the pores in the polymerized compound layer of the first liquid composition is not particularly limited and can be appropriately selected according to a particular application. Preferably, the ratio of the pore size to the median diameter of the solid electrolyte contained in the liquid composition for forming the solid electrolyte layer applied onto the polymerized compound layer of the first liquid composition is at least 0.8, and more preferably at least 1.

If the pore size in the polymerized compound layer of the first liquid composition is larger than the median diameter of the solid electrolyte, the solid electrolyte is more likely to become trapped within the pores of the polymerized compound layer of the first liquid composition. A polymerized compound layer of the first liquid composition with a pore size smaller than the median diameter of the solid electrolyte can form a structure that minimizes the inclusion of the solid electrolyte within the polymerized compound layer of the first liquid composition. This structure is advantageous for pressure distribution during pressing and for alleviating the pressure exerted by the polymerized compound layer of the first liquid composition onto the solid electrolyte layer.

There are no particular limitations on the methods of controlling the pore size and porosity of the polymerized compound layer of the first liquid composition, and they can be appropriately selected according to a particular application. Examples include, but are not limited to, adjusting the content of the first polymerizable compound in the first liquid composition, adjusting the content of the first solvent in the first liquid composition, and adjusting the irradiation conditions of beams of light.

There are no particular limitations on the volume resistivity of the polymerized compound layer of the first liquid composition, and it can be appropriately selected according to a particular application. It is preferable for the volume resistivity to be at least 10¹² Ω·cm.

The average thickness of the polymerized compound layer of the first liquid composition is not particularly limited and can be appropriately selected depending on the purpose. From the viewpoint of excellent curl suppression, a thickness of at least 10 μm is preferable, with at least 20 μm being more desirable. From the perspective of minimizing uncontrolled spreading, a thickness of at least 50 μm is preferable.

As for the method of measuring the average thickness of the polymerized compound layer of the first liquid composition, there are no particular restrictions, and it can be appropriately selected depending on the purpose. For example, measurement can be performed using a scanning electron microscope (SEM) device (Phenom Pro-X, available from Jasco International).

### Process of Applying Second Liquid Composition and Device for Applying Second Liquid Composition

In the second liquid composition application, a second liquid composition containing a second polymerizable compound and a second solvent is applied onto the polymerized compound layer of the first liquid composition.

The device for applying the second liquid composition applies the second liquid composition containing the second polymerizable compound and the second solvent onto the polymerized compound layer of the first liquid composition.

The second liquid composition application can be suitably carried out by the device for applying the second liquid composition.

The second liquid composition application and the device for applying the second liquid composition can adopt those described in Process of Applying First Liquid Composition and Device for Applying First Liquid Composition, and therefore, redundant descriptions are omitted. In other words, the process of applying the second liquid composition can adopt the process of applying the first liquid composition, and the device for applying the second liquid composition can adopt the device for applying the first liquid composition.

### Second Liquid Composition

The second liquid composition contains a second polymerizable compound and a second solvent, and may optionally furthermore contain a polymerization initiator and other components.

The second polymerizable compound can adopt the first polymerizable compound, and the second solvent can adopt the first solvent.

As the second liquid composition, a composition identical to that of the first liquid composition may be used, or a different composition may be used. When using a second liquid composition with a composition different from that of the first liquid composition, it is preferable from the viewpoint of improving adhesion to the substrate that the ratio of the content of the first polymerizable compound in the first liquid composition to the content of the second polymerizable compound in the second liquid composition (content of the first polymerizable compound in the first liquid composition/content of the second polymerizable compound in the second liquid composition) be at least 1. Additionally, from the viewpoint of suppressing interfacial peeling, it is preferable that this ratio be at most 1.5.

### Process of Forming Polymerized Compound Layer of Second Liquid Composition and Device for Forming Polymerized Compound Layer of Second Liquid Composition

In the process of forming a polymerized compound layer of the second liquid composition, the second liquid composition, which has been applied in the application of the second liquid composition, is polymerized to form a polymerized compound layer of the second liquid composition.

The device for forming a polymerized compound layer of the second liquid composition is for polymerizing the second liquid composition, which has been applied in the application of the second liquid composition, to form a polymerized compound layer of the second liquid composition.

The process of forming a polymerized compound layer of the second liquid composition is executed by the device for forming a polymerized compound layer of the second liquid composition.

Since the process of forming a polymerized compound layer of the second liquid composition and the device for forming a polymerized compound layer of the second liquid composition can adopt those described in Process of Forming Polymerized Compound Layer of First Liquid Composition and Device for Forming Polymerized Compound Layer of First Liquid Composition, redundant descriptions are omitted. In other words, the process of forming a polymerized compound layer of the second liquid composition can adopt the process of forming a polymerized compound layer of the first liquid composition, the device for forming a polymerized compound layer of the second liquid composition can adopt the device for forming a polymerized compound layer of the first liquid composition, and the polymerized compound layer of the second liquid composition can adopt the polymerized compound layer of the first liquid composition.

### Polymerized Compound Layer of Second Liquid Composition

The polymerized compound layer of the second liquid composition may have a single-layered structure or a multi-layered structure with two or more layers. A polymerized compound layer of the second liquid composition with a two or more laminar structure is preferably formed by repeatedly performing the second liquid composition application and the polymerized compound layer formation of the second liquid composition after the polymerized compound layer formation of the first liquid composition.

For convenience, in the present specification, the polymerized compound layer application of a liquid composition performed after the second liquid composition application is referred to as a third liquid composition application, and this naming convention continues thereafter.

Similarly, the polymerized compound layer formation of a liquid composition performed after the polymerized compound layer formation of the second liquid composition is referred to as the third polymerized compound layer formation of a third liquid composition, and this naming convention continues thereafter.

Furthermore, in the present specification, a polymerized compound layer of the liquid composition formed after the polymerized compound layer of the second liquid composition is referred to as a polymerized compound layer of the third liquid composition, and this naming convention continues thereafter.

The average thickness of at least one layer constituting the polymerized compound layer of the second liquid composition is preferably at least 100 μm to increase the taper length and suppress the so-called coffee ring effect, and more preferably at least 110 μm.

The porosity of the polymerized compound layer of the second liquid composition is not particularly limited and can be appropriately selected depending on the purpose. It is preferable that it be greater than the porosity of the polymerized compound layer of the first liquid composition. If the porosity of the polymerized compound layer of the first liquid composition is smaller than that of the polymerized compound layer of the second liquid composition, the adhesion of the polymerized compound layer of the first liquid composition to a substrate is improved.

### Process of Drying Polymerized Compound Layer of Liquid Composition and Device for Drying Polymerized Compound Layer of Liquid Composition

In the process of drying the polymerized compound layer of the liquid compositions, both the polymerized compound layer of the first liquid composition and the polymerized compound layer of the second liquid composition are dried.

The device for drying the polymerized compound layer of the liquid compositions dries both the polymerized compound layer of the first liquid composition and the polymerized compound layer of the second liquid composition.

The process of drying the polymerized compound layer of the liquid compositions can be suitably carried out using the device for drying the polymerized compound layer of the liquid compositions.

There are no particular restrictions on the process and the device for drying the polymerized compound layer of the liquid composition, and it can be appropriately selected depending on the purpose. For example, a drying method that involves heating the polymerized compound layers of the first and second liquid compositions may be used. In this case, it is preferable to heat under reduced pressure, as this promotes solvent removal more effectively and minimizes liquid residue in the formed layer.

Heating can be done using a stage, or a heating mechanism other than a stage may be used. The heating mechanism may be installed either above or below the substrate, or multiple heating mechanisms may be installed.

There are no particular restrictions on the heating mechanism, and it can be appropriately selected depending on the purpose. Specific examples include, but are not limited to, resistance heaters, infrared heaters, and fan heaters.

The heating temperature is not particularly limited and can be selected as appropriate. From the perspective of energy efficiency, a range of 70 to 150 degrees Celsius is preferable.

In the method of manufacturing electrodes for electrochemical elements, it is preferable to perform the second liquid composition application after the formation of the polymerized compound layer of the first liquid composition, without undergoing the polymerized compound layer drying. In this method, in the second liquid composition application, the second liquid composition can infiltrate the pores of the polymerized compound layer of the first liquid composition, thereby preventing issues related to non-uniform film formation.

### Other Optional Processes and Other Optional Devices

As for the other optional processes, there are no particular restrictions as long as they do not impair the effects of the present disclosure, and they can be appropriately selected depending on the purpose. A specific process is a conveyance.

The other optional devices are not particularly limited and can be suitably selected to suit to a particular application unless it adversely impacts the effects of the present disclosure. It includes, for example, a conveying device.

### Conveying Process and Conveying Device

The conveying process is to convey the substrate. The conveying device is to convey the substrate.

The conveying process is suitably executed by the conveying device.

There are no particular restrictions on the conveying process and conveying device as long as they enable the proceeding (conveyance) from the first liquid composition application to the polymerized compound layer formation process of the first liquid composition, from the polymerized compound layer formation process of the first liquid composition to the second liquid composition application process, from the second liquid composition application process to the polymerized compound layer formation process of the second liquid composition, and from the polymerized compound layer formation process of the second liquid composition to the polymerized compound layer drying process of the liquid composition. They can be appropriately selected depending on the purpose. Examples include, but are not limited to, a sheet-fed system and a roll-to-roll (rotary) system.

Regarding the speed of the conveying process and conveying device, from the viewpoint of productivity, a speed of 1 m/min to 100 m/min is preferable, and a speed of 30 m/min to 60 m/min is more preferable.

### Electrode for Electrochemical Element

One aspect of the electrode for an electrochemical element of the present disclosure includes a substrate, an electrode composite layer disposed on the substrate, and a structured layer disposed on at least a part of the outer periphery of the electrode composite layer, wherein the structured layer includes a laminar structure of at least two layers including a first structured layer primarily in contact with the substrate and a second structured layer disposed on the first structured layer.

Another embodiment of the electrode for an electrochemical element according to the present disclosure includes a substrate, and a structured layer having a porous structure (a porous structured layer) disposed on at least a part of the outer periphery of the electrode composite layer, wherein the structured layer includes a laminar structure of at least two layers including a first structured layer primarily in contact with the substrate and a second structured layer disposed primarily in contact with the first structured layer, the second structured layer has a porosity greater than the porosity of the first structured layer.

The electrode for an electrochemical element can be obtained by executing the method of manufacturing the electrode for an electrochemical element according to the present disclosure.

In the present specification, the term “electrode” collectively refers to both the negative electrode and the positive electrode, the term “substrate” collectively refers to both the negative electrode substrate and the positive electrode substrate, and the term “electrode composite layer” collectively refers to both the negative electrode composite layer and the positive electrode composite layer.

An embodiment of the electrode for an electrochemical element obtained by the method of manufacturing the electrode for an electrochemical element according to the present disclosure will be described with reference to the drawings. The present disclosure is not limited to these embodiments.

In the drawings, identical components may be denoted by the same reference numerals (or symbols), and redundant descriptions may be omitted. Additionally, the present disclosure is not restricted to the specific numbers, positions, or shapes of the configurations described below. These parameters may be appropriately selected to suit the implementation of the present disclosure.

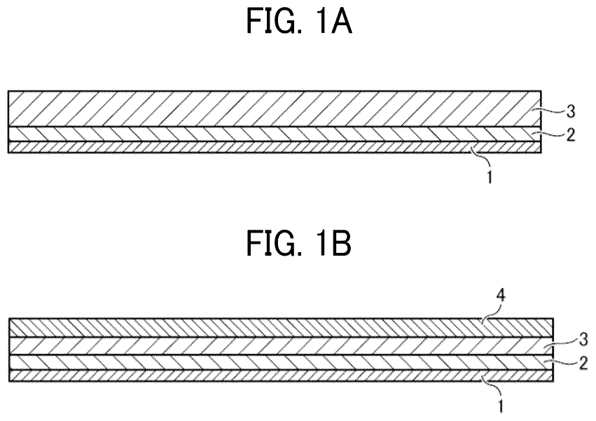

### FIG. 1A

FIG. 1A is a schematic diagram illustrating a cross-sectional view of an electrode for an electrochemical element obtained by executing the method of manufacturing an electrode for an electrochemical element relating to an embodiment of the present disclosure;

The electrode for an electrochemical element includes a substrate 1, a first structured layer 2 formed of the first liquid composition on at least part of the substrate 1, and a second structured layer 3 formed of the second liquid composition on the first structured layer 2.

FIG. 1A illustrates a configuration in which the first structured layer 2 and the second structured layer 3 are provided on one side of the substrate 1. The first structured layer 2 and the second structured layer 3 may also be provided on both opposing sides of the substrate 1.

### FIG. 1B

FIG. 1B is a schematic diagram illustrating a cross-sectional view of an electrode for an electrochemical element obtained by executing the method of manufacturing an electrode for an electrochemical element relating to another embodiment of the present disclosure.

The electrode for an electrochemical element includes the substrate 1, the first structured layer 2 formed of a first liquid composition on at least part of the substrate 1, the second structured layer 3 formed of the second liquid composition on the first structured layer 2, and a third structured layer 4 formed of the second liquid composition on the second structured layer 3.

FIG. 1B illustrates a configuration in which the first structured layer 2, the second structured layer 3, and the third structured layer 4 are provided on one side of the substrate 1. The first structured layer 2, the second structured layer 3, and the third structured layer 4 may also be provided on both opposing sides of the substrate 1.

Additionally, fourth and subsequent structured layers may also be further provided.

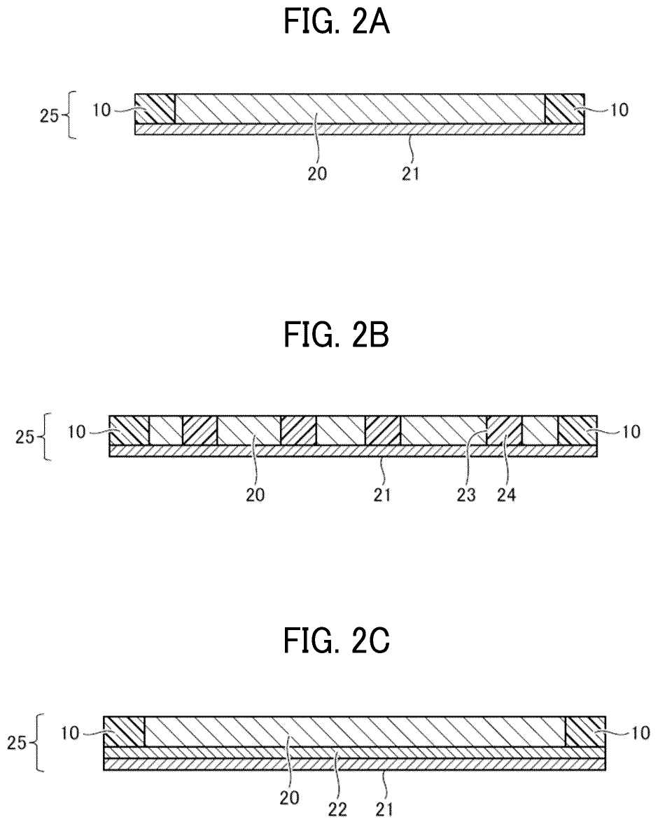

### FIG. 2A

FIG. 2A is a schematic cross-sectional diagram illustrating an electrode for an electrochemical element according to one embodiment of the present disclosure. An electrode 25 for an electrochemical element includes a first substrate 21, an electrode composite layer 20 disposed on the first substrate 21, and a structured layer 10 disposed at the outer periphery of the electrode composite layer 20.

FIG. 2A illustrates a configuration in which the electrode composite layer 20 and the structured layer 10 are disposed on one side of the first substrate 21. The electrode composite layer 20 and the structured layer 10 may also be disposed on both opposing sides of the first substrate 21.

Note that in FIG. 2A, the laminated structure of the structured layer 10 is omitted.

### Substrate

The substrate in the electrode for an electrochemical element can adopt the one described in Method of Manufacturing Electrode for Electrochemical Element and Device for Manufacturing Electrodes for Electrochemical Element.

The electrode composite layer may be disposed on the substrate.

### Electrode Composite Layer

The electrode composite layer (also referred to as the active material layer) is primarily made of an active material (either a negative electrode active material or a positive electrode active material). In the present specification, primarily made of an active material means that the active material content is at least 70 percent by mass of the entire electrode composite layer.

The electrode composite layer is formed of a liquid composition for forming an electrode composite layer.

There are no particular restrictions on the liquid composition for forming an electrode composite layer, and it can be appropriately selected depending on the purpose. For example, it may contain an active material (either a negative electrode active material or a positive electrode active material). The liquid composition may furthermore optionally contain a conductive additive, binder for the electrode composite layer, dispersant for the electrode composite layer, solid electrolyte, gel electrolyte, solvent for the electrode composite layer, and other components.

### Active Material

The active material can be either a positive electrode active material or a negative electrode active material. The positive electrode active material or negative electrode active material may be used alone or in combination of two or more.

### Positive Electrode Active Material

There is no particular limitation on the positive electrode active material as long as it is a material capable of reversibly absorbing and releasing alkali metal ions. For example, alkali metal-containing transition metal compounds can be used as the positive electrode active materials.

Specific examples of alkali metal-containing transition metal compounds include, but are not limited to, lithium-containing transition metal compounds such as composite oxides containing lithium and one or more elements selected from the group consisting of cobalt, manganese, nickel, chromium, iron, and vanadium.

Specific examples of lithium-containing transition metal compounds include lithium cobalt oxide, lithium nickel oxide, and lithium manganese oxide.

Alkali metal-containing transition metal compounds may also include polyanion compounds having an XO₄ tetrahedron (where X=P, S, As, Mo, W, Si, etc.) in their crystal structure. Of these, lithium-containing transition metal phosphate compounds such as lithium iron phosphate and lithium vanadium phosphate are preferable in terms of cyclability. Lithium vanadium phosphate is more preferable in terms of lithium diffusion coefficient and output properties.

As for the polyanion compounds, it is preferable that the surface is coated and compounded with conductive additives such as carbon materials to enhance electronic conductivity.

It is preferable for alkali metal-containing transition metal compounds to be at least partially coated with an ion-conductive oxide on their surface. As the ion-conductive oxide, lithium ion-conductive oxides are preferable.

There are no particular limitations on the selection of lithium ion-conductive oxides, which can be selected according to a particular application.

Specific examples include, but are not limited to, oxides represented by Chemical Formula LiₓAO_{y} (where A represents B, C, Al, Si, P, S, Ti, Zr, Nb, Mo, Ta, Sc, V, Y, Ca, Sr, Ba, Hf, Ta, Cr, or W, and x and y are positive numbers).

Specific examples of lithium ion-conductive oxides include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, LiTaO₃, Li₂MoO₄, and Li₂WO₄. Among these, Li₄Ti₅O₁₂, Li₂ZrO₃, or LiNbO₃ is preferable.

Lithium ion-conductive oxides may also be composite oxides. Any combination of lithium ion-conductive oxides may be used as composite oxides, such as Li₄SiO₄—Li₃BO₃ and Li₄SiO₄—Li₃PO₄.

### Negative Electrode Active Material

As for the negative electrode active material, there are no particular limitations as long as it is a material capable of reversibly absorbing and releasing alkali metal ions, and it can be appropriately selected according to a particular application.

For example, carbon materials containing graphite with a graphite-type crystalline structure can be used.

Examples of carbon materials include, but are not limited to, natural graphite, spherical or fibrous artificial graphite, hard carbon (non-graphitizable carbon), and soft carbon (easily graphitizable carbon).

In addition to carbon materials, examples of other materials include, but are not limited to, lithium titanate and titanium oxide.

High-capacity materials such as silicon, tin, silicon alloys, tin alloys, silicon oxide, silicon nitride, and tin oxide can also be suitably used as negative electrode active materials to increase the energy density of lithium-ion batteries.

### Conductive Assistant

The conductive assistant is not particularly limited and can be suitably selected to suit to a particular application. Examples of the conductive assistant include, but are not limited to, carbon black produced by a method such as a furnace method, an acetylene method, and a gasification method, and carbon materials such as carbon nanofibers, carbon nanotubes, graphene, and graphite particles.

Conductive assistants other than the carbon materials include, but are not limited to, metal particles and metal fiber of aluminum. The conductive assistant may be combined with an active material in advance.

The content of the conductive assistant to an active material is not particularly restricted and can be adjusted according to a particular application. It is preferable for the content to be at most 10 percent by mass, with a more preferable range of at most 8 percent by mass. From the perspective of reducing the resistance of the active material and imparting conductivity, it is preferable for the content to be at least 1 percent by mass.

A content of the conductive assistant to an active material of at most 10 percent by mass is suitable for enhancing the stability of the liquid composition for forming an electrode composite layer.

A content of the conductive assistant to an active material of at most 8 percent by mass is suitable for further enhancing the stability of the liquid composition for forming an electrode composite layer.

### Binder for Electrode Composite Layer

As long as the binder for an electrode composite layer can bind the negative electrode materials to each other, the positive electrode materials to each other, the negative electrode materials to the negative electrode substrate, and the positive electrode materials to the positive electrode substrate, it is not particularly limited and can be appropriately selected according to a particular application. If the liquid composition for forming the electrode composite layer is used for inkjet discharging, it is preferable that the binder for an electrode composite layer minimally increase the viscosity of the liquid composition for forming the electrode composite layer, to minimize nozzle clogging in the liquid discharging head.

In the present specification, the binder for an insulating layer in the liquid composition for forming the insulating layer is distinguished from the binder for an electrode composite layer in the liquid composition for forming the electrode composite layer.

As the binder for forming an electrode composite layer, polymer compounds can be used.

Examples include, but are not limited to, thermoplastic resins such as polyvinylidene fluoride (PVDF), acrylic resin, polyethylene, polypropylene, polyurethane, nylon, polytetrafluoroethylene, polyphenylene sulfide, polyethylene terephthalate, polybutylene terephthalate, polyamide compounds, polyimide compounds, polyamide-imide, ethylene-propylene-butadiene rubber (EPBR), styrene-butadiene rubber (SBR), nitrile butadiene rubber (NBR), isoprene rubber, polyisobutene, polyethylene glycol (PEO), polymethyl methacrylate (PMMA), and polyethylene vinyl acetate (PEVA).

The content of the binder for forming an electrode composite layer to an active material is not particularly restricted and can be appropriately set depending on the purpose. It is preferable that the content be between 1 percent by mass and 15 percent by mass, with a more preferable range between 3 percent by mass and 10 percent by mass.

If the content of the binder for forming an electrode composite layer to an active material is at least 1 percent by mass, it is suitable for strongly binding the active material to the substrate.

### Dispersant for Electrode Composite Layer

As long as it can improve the dispersibility of the active material within the liquid composition for forming the electrode composite layer, the dispersant for the electrode composite layer is not particularly restricted.

Examples include, but are not limited to, polymer dispersants such as polyethylene oxide, polypropylene oxide, polycarboxylic acid, naphthalene sulfonic acid formalin condensates, polyethylene glycol, polycarboxylic acid partial alkyl esters, polyether, and polyalkylene polyamine; low molecular weight dispersants such as alkyl sulfonic acid, quaternary ammonium alkylene oxide of higher alcohols, polyvalent alcohol esters, and alkyl polyamines; and inorganic dispersants such as polyphosphate-based dispersants.

In the present specification, the term “dispersant for an insulating layer” in the liquid composition for forming the insulating layer is distinguished from the term “dispersant for an electrode composite layer” in the liquid composition for forming the electrode composite layer.

### Solid Electrolyte

As long as it is a solid substance that possesses electronic insulation and exhibits ionic conductivity, there are no particular restrictions on the solid electrolyte. Sulfide solid electrolytes and oxide solid electrolytes are preferred to achieve high ionic conductivity.

Examples of sulfide solid electrolytes include, but are not limited to, Li₁₀GeP₂S₁₂ and Li₆PS₅X (X=F, Cl, Br, I) with an argyrodite-type crystal structure.

Examples of oxide solid electrolytes include, but are not limited to, LLZ (Li₇La₃Zr₂O₁₂) with a garnet-type crystal structure, LATP (Li₁₊ₓAlₓTi₂₋ₓ(PO₄)₃) (0.1≤x≤0.4) with a NASICON-type crystal structure, LLT (Li_{0.33}La_{0.55}TiO₃) with a perovskite-type crystal structure, and amorphous LIPON (Li_{2.9}PO_{3.3}N_{0.4}).

These solid electrolytes can be used either alone or in combination of two or more types.

If the electrode composite layer is a positive electrode composite layer, there are no particular restrictions on its average thickness, and it can be appropriately selected depending on the purpose. A thickness of 10 μm to 300 μm is preferable, and a thickness of 40 μm to 150 μm is more preferable.

If the average thickness of the positive electrode composite layer is at least 10 μm, the energy density of the electrochemical element increases.

If the average thickness of the positive electrode composite layer is at most 300 μm, the load properties of the electrochemical element are improved.

If the electrode composite layer is a negative electrode composite layer, there are no particular restrictions on its average thickness, and it can be appropriately selected depending on the purpose. A thickness of 10 μm to 450 μm is preferable, and a thickness of 20 μm to 100 μm is more preferable.

If the average thickness of the negative electrode composite layer is at least 10 μm, the energy density of the electrochemical element increases.

If the average thickness of the negative electrode composite layer is at most 450 μm, the cycle performance of the electrochemical element is improved.

One embodiment of the electrode relating to the present disclosure are described with reference to the drawings. The present disclosure is not limited to these embodiments.

### FIG. 2B

FIG. 2B is a schematic cross-sectional diagram illustrating an electrode for an electrochemical element according to another embodiment of the present disclosure.

The electrode composite layer may have an opening 23 as illustrated in FIG. 2B.

The number of openings 23 is preferably one or more, and more preferably multiple.

The openings 23 may penetrate the electrode composite layer from the surface of the electrode composite layer to the surface of the substrate, or it may not penetrate to the surface of the substrate.

The openings 23 may be hollow or filled with a material 24. If the openings 23 are filled with the material 24, the material 24 may be a single substance or a mixture of two or more substances, but in either case, the material 24 should be different in nature from the material constituting the electrode composite layer. The material 24 preferably contains a solid electrolyte to improve the ionic conductivity.

An electrode composite layer with the openings 23 can be suitably manufactured using inkjet as an electrode composite layer forming device because coating control is easy.

### FIG. 2C

FIG. 2C is a schematic diagram illustrating a top view of an electrode for another electrochemical element according to one embodiment of the present disclosure.

Furthermore, as illustrated in FIG. 2C, the electrode composite layer may have an adhesive layer 22 containing a metal that forms an alloy with lithium between the first substrate 21 and the electrode composite layer 20.

### Structured Layer

The structured layer has a laminar structure with two or more layers, including the first structured layer primarily in contact with the substrate and the second structured layer disposed on the first structured layer.

The electrode for an electrochemical element is obtained by the method of manufacturing an electrode for an electrochemical element. Since the first structured layer corresponds to the polymerized compound layer of the first liquid composition and the second structured layer corresponds to the polymerized compound layer of the second liquid composition, redundant descriptions are omitted.

In the present specification, “primarily in contact with the substrate” means that the structured layer has the largest contact area with the substrate.

In the electrode for an electrochemical element, the porosity of the second structured layer is greater than that of the first structured layer. This improves the adhesion of the first structured layer to the substrate.

If the electrode composite layer is provided on the substrate, the structured layer is preferably disposed at the outer periphery of the electrode composite layer.

In the present specification, “disposed at the outer periphery of the electrode composite layer” means that the structured layer may be placed along at least two sides, three sides, or all four sides of the outer periphery of the electrode composite layer. Additionally, the insulating layer may include recesses or notches on any side to allow the electrode tab to protrude.

The shape and placement area of the structured layer will be explained with reference to the drawings. The present disclosure is not limited to these embodiments.

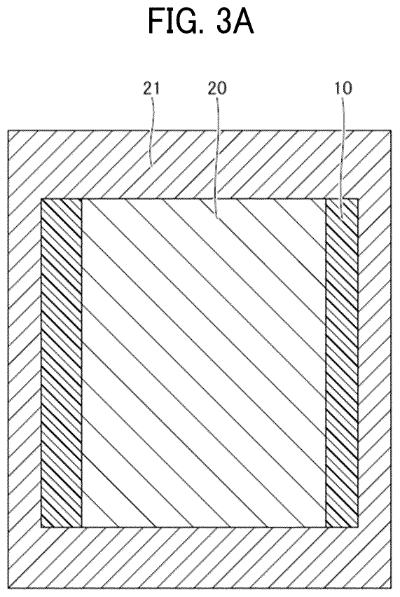

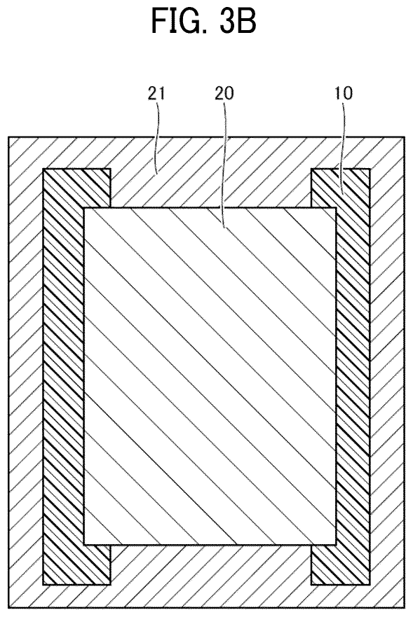

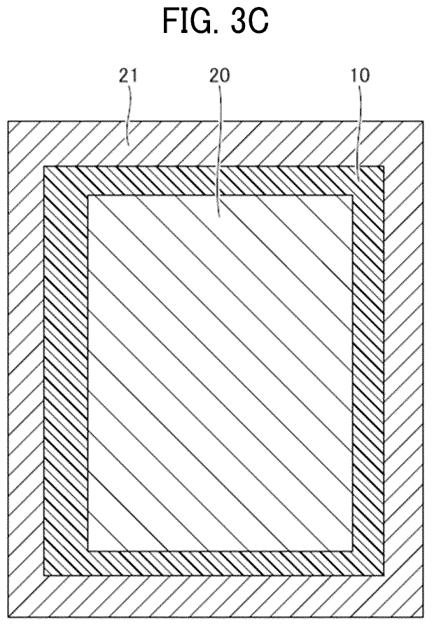

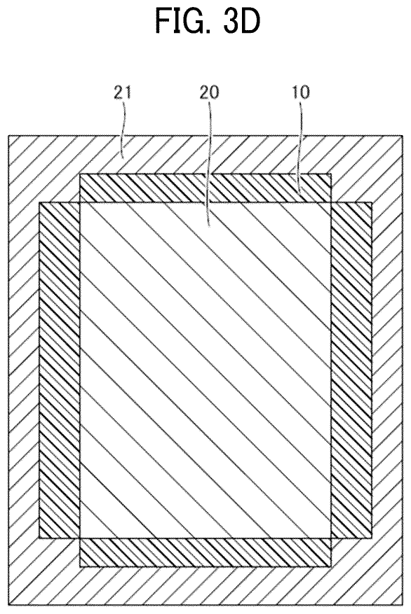

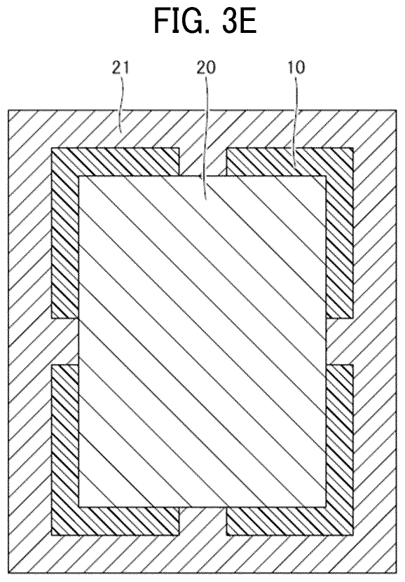

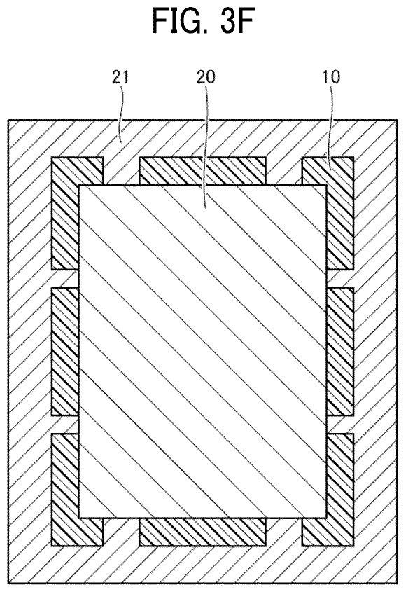

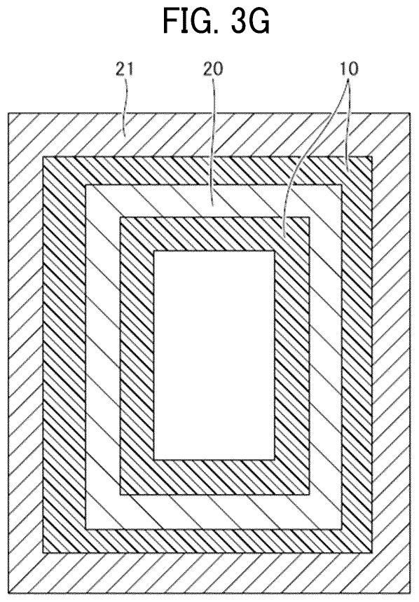

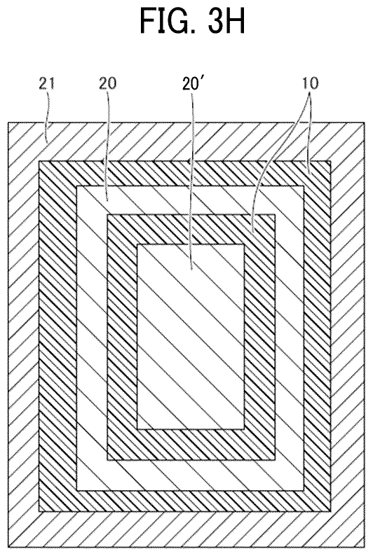

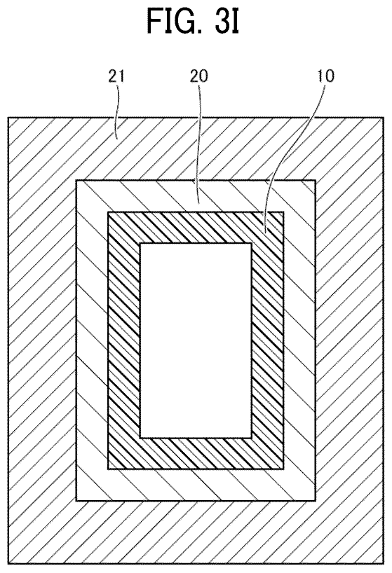

### FIG. 3A

FIG. 3A is a schematic diagram illustrating a top view of an electrode for an electrochemical element according to one embodiment of the present disclosure.

In FIG. 3, the structured layer 10 is disposed in contact with two sides of the outer periphery of the electrode composite layer 20.

### FIG. 3B

FIG. 3B is a schematic diagram illustrating a top view of an electrode for another electrochemical element according to one embodiment of the present disclosure.

In FIG. 3B, the structured layer 10 is disposed in contact with the two long sides of the outer periphery of the electrode composite layer 20, as well as to the two corners of those long sides.

### FIG. 3C

FIG. 3C is a schematic diagram illustrating a top view of an electrode for another electrochemical element according to one embodiment of the present disclosure.

In FIG. 3C, the structured layer 10 is disposed continuously in contact with all four sides of the outer periphery of the electrode composite layer 20. The structured layer 10 may also be provided in contact with the sides in a discontinuous manner.

### FIGS. 3D to 3F

FIGS. 3D to 3F are schematic diagrams illustrating top view of electrodes for electrochemical elements according to other embodiments of the present disclosure.

In FIGS. 3D to 3F, the structured layer 10 is disposed discontinuously in contact with all four sides of the outer periphery of the electrode composite layer 20.

As illustrated in FIGS. 3D to 3F, if the structured layer 10 is disposed partially adjacent, it may be arranged in a manner where it is disposed partially adjacent to one or more edges of the electrode composite layer 20 (FIG. 3D), disposed partially adjacent to one or more corners of the electrode composite layer 20 (FIG. 3E), or a combination of these arrangements (FIG. 3F).

### FIGS. 3G to 3I

FIGS. 3G to 3I are schematic diagrams illustrating a top view of electrodes for electrochemical elements according to other embodiments of the present disclosure.

The interior of the outer edge of the electrode composite layer 20 does not necessarily have to be entirely coated. That is, the electrode composite layer 20 may have openings or uncoated portions, and the structured layer 10 may be disposed on both the outer peripheral portion and the inner peripheral portion of the electrode composite layer 20, as illustrated in FIG. 3G. Additionally, the structured layer 20 disposed on the inner peripheral portion may further have an electrode composite layer 20′ formed inside it, as illustrated in FIG. 3H.

Even if the structured layer 10 is disposed on the inner peripheral portion of the electrode composite layer 20 with an opening, it may be disposed discontinuously adjacent to one or more inner edges of the electrode composite layer 20 or disposed discontinuously adjacent to one or more inner corners of the electrode composite layer 20. A combination of these configurations may also be employed. Furthermore, a structure in which the structured layer 10 is disposed only on the inner peripheral portion of the electrode composite layer 20 with an opening, as illustrated in FIG. 3I, may also be adopted.

The structured layer preferably has insulating properties. In the present specification, “having insulating properties” means that the volume resistivity of the structured layer is at least 1×10¹² (Ω·cm).

One method of imparting insulating properties to the structured layer includes adding insulating inorganic particles to the first liquid composition and the second liquid composition, for example.

In the present specification, a structured layer with insulating properties may be referred to as an “insulating layer,” and the liquid composition used to form the insulating layer may be referred to as an “insulating layer forming liquid composition.”

### Liquid Composition for Forming Solid Electrolyte Layer

The insulating layer forming liquid composition contains the “first liquid composition” or the “second liquid composition” described in “Method of Manufacturing Electrode for Electrochemical Element and Device for Manufacturing Electrode for Electrochemical Element.” It may furthermore optionally contain insulating inorganic particles, a dispersant for the insulating layer, a binder for the insulating layer, a solvent for the insulating layer, and other necessary components.

### Insulating Inorganic Particles

There are no particular restrictions on the insulating inorganic particles as long as they have a volume resistivity of at least 10⁸ Ω·cm, and they can be appropriately selected depending on the purpose. Examples include, but are not limited to, aluminum oxide (alumina), boehmite, silica, aluminum nitride, silicon nitride, cordierite, sialon, mullite, steatite, yttria, zirconia, and silicon carbide. Among these, inorganic oxides are preferred. From the perspective of heat resistance, aluminum oxide and boehmite are more preferred, with α-alumina being the most preferred.

α-alumina is known to function as a scavenger for ‘junk’ chemical species, which can cause capacity fade in lithium-ion secondary batteries. Additionally, alumina particles exhibit excellent wettability and affinity with electrolytes, improving the cycle performance of lithium-ion secondary batteries. By using a-alumina as the insulating inorganic particles, the insulating layer-forming liquid composition benefits from improved redispersibility and inkjet discharging properties, while the insulating layer itself gains enhanced heat resistance.

These insulating inorganic particles can be used alone or in a combination of two or more thereof.

There are no particular restrictions on the shape of the insulating inorganic particles, and they can be selected as appropriate depending on the intended purpose. Examples include rectangular, spherical, elliptical, cylindrical, egg-shaped, dog-bone-shaped, and amorphous forms. Among these, from the viewpoint of improving inkjet discharging properties, it is preferable that the aspect ratio of the long and short axes of the insulating inorganic particles be close to 1.

There are no particular restrictions on the median diameter of the insulating inorganic particles, and it can be appropriately selected according to a particular application. It is preferably between 200 nm and 1,000 nm.

If the median diameter of the insulating inorganic particles is at least 200 nm, it helps prevents the particles from dispersing into the air (mist formation) during inkjet discharging. Additionally, in the insulating layer, it helps prevent the insulating inorganic particles from attaching onto the substrate due to the loss of fine particles.

If the median diameter of the insulating inorganic particles is at most 1,000 nm, it helps prevent nozzle clogging during inkjet discharging, thereby improving discharging performance. Furthermore, in the insulating layer, it promotes uniform thickness and homogenization (reducing irregularities), making it preferable.

There are no particular restrictions on the method of measuring the median diameter of the insulating inorganic particles, and it can be appropriately selected according to a particular application. Examples include, but are not limited to, dynamic light scattering, photon correlation spectroscopy, laser diffraction, centrifugal sedimentation, and induced diffraction methods. More specifically, after diluting the liquid composition so that the solid content is at most 10 percent by mass, the measurement can be performed using a high-concentration particle size analyzer (FPAR-1000, available from Otsuka Electronics Co., Ltd.).

It is preferable that the insulating inorganic particles contain a first insulating inorganic particle with a median diameter of 200 nm to less than 1,000 nm, and a second insulating inorganic particle with an average Stokes diameter of less than 30 nm. The average Stokes diameter refers to the average major axis length of the particles, measured by Transmission Electron Microscopy (TEM).

If the second insulating inorganic particle with an average Stokes diameter of less than 30 nm are contained, the energy barrier in the potential energy of interparticle interactions can be sufficiently reduced. This helps resolve issues where, after long-term standing of the liquid composition, the inorganic particles aggregate and are not redispersed even upon re-stirring.

There are no particular restrictions on the content of insulating inorganic particles, and it can be appropriately selected according to a particular application. In order to ensure the insulating layer after drying has a uniform thickness, it is preferable that the insulating layer forming liquid composition contain at least 10 percent by mass, and more preferably at least 20 percent by mass of the insulating inorganic particles. From the perspective of viscosity, it is preferable that the total content of the insulating inorganic particles in the insulating layer forming liquid composition does not exceed 60 percent by mass, and for better inkjet discharging properties, it is more preferable that it do not exceed 55 percent by mass.

The insulating inorganic particles can be synthesized or procured.

Specific examples of the commercially available aluminum oxide products that can be used as the insulating inorganic particles include, but are not limited to, High-purity alumina (available from Sumitomo Chemical Co., Ltd.): AKP-15, AKP-20, AKP-30, AKP-50, AKP-53, AKP-700, AKP-3000, AA-03, AA-04, AA-05, AA-07, AA-1.5, AKP-G07, and AKP-G15; TM-DA, TM-DAR, and TM-5D, (all available from TAIMEI CHEMICALS Co., Ltd.; CT-3000 LSSG, available from Almatis; LS-502, LS-711CB, and SLS-710, available from Nippon Light Metal Company, Ltd.; SEPal-60, and SEPal-70, available from Alteo.

One specific commercially available boehmite product that can be used as the insulating inorganic particles is BMB-07, available from KAWAI LIME INDUSTRY Co., Ltd.

### Other Optional Components

The insulating layer forming liquid composition may also include other components for purposes such as viscosity adjustment, particle size adjustment, surface tension control, evaporation control of non-aqueous solvents, improved solubility of additives, enhanced particle dispersibility, and sterilization. These components may include surfactants, pH adjusters, rust inhibitors, preservatives, antifungal agents, antioxidants, anti-reducing agents, evaporation accelerators, and chelating agents.

There are no particular restrictions on the content of these other components, and it can be appropriately set according to the content of various components in the insulating layer forming liquid composition.

There are no particular restrictions on the average thickness of the insulating layer (structured layer), and it can be appropriately selected according to various conditions such as the average thickness of the electrode composite layer. It is preferably 1.0 μm to 150.0 μm, and more preferably 10.0 μm to 100.0 μm.

An average thickness of the insulating layer (structured layer) of at least 10.0 μm can suitably distribute the pressure load during pressing and prevent short circuits between the positive and negative electrodes.

If the average thickness of the insulating layer (structured layer) is at most 100.0 μm, it is possible to manufacture an electrochemical element with high density and excellent battery characteristics.

There are no particular restrictions on the compression ratio of the insulating layer (structured layer) after pressing at 500 MPa for 5 minutes, and it can be appropriately selected depending on the purpose. It is preferably between 1 percent and 50 percent, and more preferably between 5 percent and 20 percent.

A compression ratio of the strength of the insulating layer (structured layer) of at most 50 percent ensures adequate shape retention after the pressing process.

A compression ratio of the insulating layer of the insulating layer (structured layer) of at least 1 percent alleviates the pressure on the solid electrolyte layer from the insulating layer (structured layer) during the pressing process after the solid electrolyte layer is formed.

It is preferable for the insulating layer (structured layer) to have a co-continuous structure.

If the insulating layer (structured layer) has a co-continuous structure, it allows for precise and easy thickness control of the insulating layer (structured layer) through pressing, especially when its thickness is made approximately equal to that of the electrode composite layer. Additionally, the thickness of the insulating layer (structured layer) can also be easily controlled by forming it using the polymerization-induced phase separation method. If the insulating layer (structured layer) is a porous co-continuous structure, it can efficiently disperse the pressure generated during pressing. This structure helps prevent issues such as damage to the insulating layer (structured layer), uneven surface height variations, and other defects, thereby ensuring a high-quality insulating layer (structured layer).

In electrochemical devices where short circuits can potentially occur due to dendrite deposition, it is generally common to configure the negative electrode composite layer to be larger than the positive electrode composite layer. In this case, if the positive and negative current collectors are approximately the same size, a surplus area where the positive electrode composite layer is not formed will be present in the region on the positive current collector where it faces the negative electrode composite layer. From the perspective of electrochemical element properties, it is preferable for the insulating layer (structured layer) to be disposed on the excess portion of the positive electrode, that is, on the outer peripheral portion of the positive electrode composite layer. However, if the electrochemical element is designed such that the negative electrode composite layer is smaller than the positive electrode composite layer, then it is preferable for the insulating layer (structured layer) to be disposed on the excess portion of the negative electrode, that is, on the outer peripheral portion of the negative electrode composite layer.

Embodiment of the present disclosure are described with reference to the drawings. The present disclosure is not limited to these embodiments.

In the drawings, identical components may be denoted by the same reference numerals (or symbols), and redundant descriptions may be omitted. Additionally, the present disclosure is not restricted to the specific numbers, positions, or shapes of the configurations described below. These parameters may be appropriately selected to suit the implementation of the present disclosure.

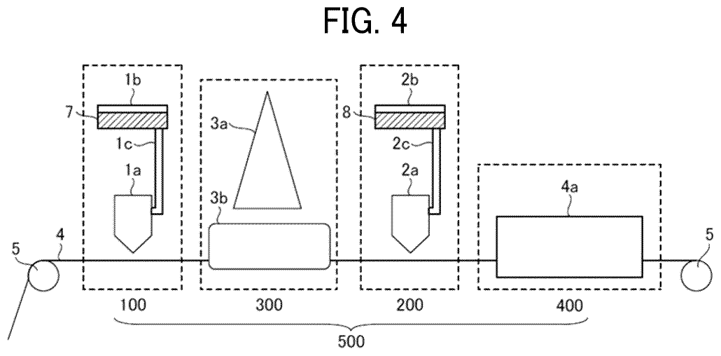

FIG. 4: Embodiments for Forming Structured Layer or Electrode for Electrochemical Element by Applying Liquid Composition to Substrate

FIG. 4 is a schematic diagram illustrating the method of manufacturing an electrode for an electrochemical element according to an embodiment of the present disclosure.

A device 500 for manufacturing an electrochemical element manufactures a structured layer using a liquid composition. The device 500 for manufacturing an electrochemical element includes the following elements:
A first printing unit 100 that performs the first liquid composition application for applying a first liquid composition 7 onto the substrate 4 to form a first liquid composition film;
A second printing unit 200 that performs the second liquid composition application for applying a second liquid composition 8 to form a second liquid composition film;
A polymerization unit 300 that applies heat or light to the first and second liquid composition films to perform the polymerized compound layer formation of the first liquid composition; and
A heating unit 400 that applies heat to the precursors of the structured layer to remove the solvent in the pores, thereby forming the structured layer.

The device 500 for manufacturing an electrochemical element is equipped with a conveying unit 5 that conveys the substrate 4. The conveying unit 5 moves the substrate 4 at a predetermined speed in the following order of the first printing unit 100, the polymerization unit 300, the second printing unit 200, and the heating unit 400.

### First Printing Unit 100

The first printing unit 100 includes:
A printing unit la that applies the first liquid composition 7 onto the substrate 4;
A storage container 1b that stores the first liquid composition 7; and
A supply tube 1c that supplies the first liquid composition 7 from the storage container 1b to the printing device 1a.

The storage container 1b stores the first liquid composition 7, and the printing unit 100 discharges the first liquid composition 7 from the printing device 1a, applying it onto the substrate 4. The storage container 1b may be configured in an integrated manner with a device for manufacturing an electrode for an electrochemical element. Alternatively, it can be configured removable from a device for manufacturing an electrode for an electrochemical element. In addition, the storage container 1b may be configured to add the liquid composition 7 to a container integrated with a device for manufacturing an electrode of an electrochemical element or a container detachable from a device for manufacturing an electrode for an electrochemical element.

The storage container 1b and the supply tube 1c can be freely-selected as long as the first liquid composition 7 can be stably stored and supplied. It is preferable that the materials constituting the storage container 1b and supply tube 1c have light-shielding properties in the range of ultraviolet and the relatively short wavelength regions of the visible light. Due to this light shielding property, the liquid composition 7 is prevented from starting being polymerized by external light.

### Second Printing Unit 200

The second printing unit 200 includes:
A printing device 2a that applies the second liquid composition 8 onto the substrate 4;
A storage container 2b that stored the second liquid composition 8; and
A supply tube 2c that supplies the second liquid composition 8 from the storage container 2b to the printing device 2a.

The storage container 2b stores the second liquid composition 8, and the second printing unit 200 discharges the second liquid composition 8 from the printing unit 2a, applying it onto the substrate 4. The storage container 2b may be configured in an integrated manner with a device for manufacturing an electrode for an electrochemical element. Alternatively, it can be configured removable from a device for manufacturing an electrode for an electrochemical element. In addition, the storage container 1b may be configured to add the liquid composition 7 to a container integrated with a device for manufacturing an electrode of an electrochemical element or a container detachable from a device for manufacturing an electrode for an electrochemical element.

The storage container 2b and the supply tube 2c can be freely-selected as long as the second liquid composition 8 can be stably stored and supplied. It is preferable that the materials constituting the storage container 2b and supply tube 2c have light-shielding properties in the range of ultraviolet and the relatively short wavelength regions of the visible light. Due to this light shielding property, the second liquid composition 8 is prevented from starting being polymerized by external light.

### Polymerization Unit 300

In the case of photopolymerization, the polymerization unit 300, as illustrated in FIG. 4, includes:
A light irradiation device 3a, which carries out the polymerized compound layer formation of the first liquid composition; and
A polymerization-inert gas circulation device 3b, which circulates polymerization-inert gas.

The light irradiation device 3a irradiates the first liquid composition film, formed by the printing unit 100, with light in the presence of polymerization-inert gas, inducing photopolymerization to obtain a precursor of the structured layer.

The light irradiation device 3a is appropriately selected depending on the absorption wavelength of the photopolymerization initiator contained in the first liquid composition layer and is not particularly limited as long as it can start and proceed the polymerization of the compound in the first liquid composition. For example, ultraviolet light sources such as a high-pressure mercury lamp, a metal halide lamp, a hot cathode tube, a cold cathode tube, and an LED can be used. However, since light having a shorter wavelength generally tends to reach a deep part, it is preferable to select a light source according to the thickness of the structured layer to be formed.

Next, regarding the irradiation intensity of the light source of the light irradiation device 3a, if the irradiation intensity is too strong, the polymerization proceeds rapidly before the phase separation sufficiently occurs, so that a porous structure tends to be difficult to obtain. In addition, when the irradiation intensity is too weak, the phase separation proceeds more than the microscale and the porous variation and the coarsening are likely to occur. In addition, the irradiation time becomes longer and the productivity tends to decline. Therefore, the irradiation intensity is preferably 10 mW/cm² to 1 W/cm² and more preferably from 30 to 300 mW/cm².

Next, the polymerization inert gas circulation device 3b plays a role of reducing the polymerization active oxygen concentration contained in the atmosphere and allowing the polymerization reaction of the polymerizable compound near the surface of the liquid composition to proceed without inhibition. Therefore, the polymerization inert gas used is not particularly limited as long as it satisfies the function mentioned above. For example, nitrogen, carbon dioxide, and argon can be used.

It is preferable to maintain the O₂ concentration in the inert gas below 20 percent (a lower oxygen concentration than in the atmosphere) to achieve a greater inhibition reduction effect. More preferably, the O₂ concentration should be between 0 and 15 percent, and even more preferably between 0 and 5 percent. Additionally, it is preferable for the polymerization inert gas circulation device 3b to be equipped with a temperature control device to ensure stable polymerization conditions.

The polymerization unit 300 may be a heating device in the case of thermal polymerization. There are no particular limitations on the heating device, and it can be appropriately selected according to the purpose. Examples include, but are not limited to, substrate heating (such as hot plates), IR heaters, and hot air heaters, which may also be used in combination.

Additionally, the heating temperature and time, or the conditions for light irradiation, can be appropriately selected according to the polymerizable compounds contained in the first liquid composition 7 and the second liquid composition 8 and the thickness of the formed film.

### Heating Unit 400

The heating unit 400, as illustrated in FIG. 4, includes a heating device 4a and performs a polymerized composition layer drying. During drying, the precursor of the structured layer formed by the polymerization unit 300 is heated by the heating device 4a to dry and remove the residual solvent. The structured layer is thus formed. The heating unit 400 performs heating may be conducted under reduced pressure.

The heating unit 400 may also promote polymerization process, in which the precursor of the structured layer is heated by the heating device 4a to further promote the polymerization reaction carried out in the polymerization unit 300. Additionally, it may perform initiator removal, in which the photopolymerization initiator remaining in the precursor of the structured layer is heated and dried by the heating device 4a. These polymerization promotion and initiator removal are not necessarily conducted simultaneously with the polymerized compound layer formation of the first and second liquid compositions; they may be carried out before or after these formation processes.

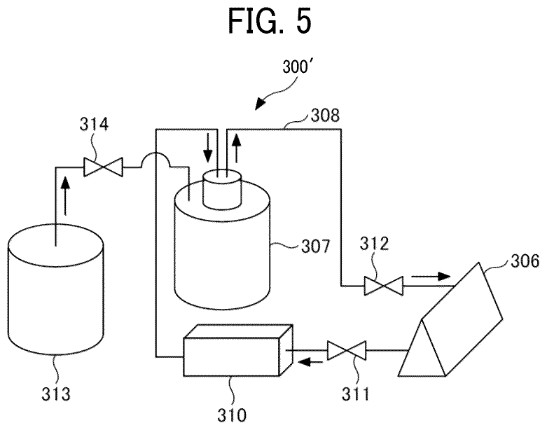

### FIG. 5

FIG. 5 is a schematic diagram illustrating the device (liquid discharging device) for manufacturing an electrode for an electrochemical element according to an embodiment of the present disclosure.

A liquid discharging device 300′ circulates the liquid compositions in a liquid discharging head 306, a tank 307, and a tube 308 by adjusting a pump 310 and valves 311 and 312.

The liquid discharging device 300′ is equipped with an external tank 313, allowing the liquid composition to be supplied from the external tank 313 to the tank 307 by adjusting the pump 310 and operating the valves 311, 312, and 314 when the liquid composition in the tank 307 decreases.

With such a device for manufacturing an electrode for electrochemical element, the liquid composition can be discharged onto the target position.

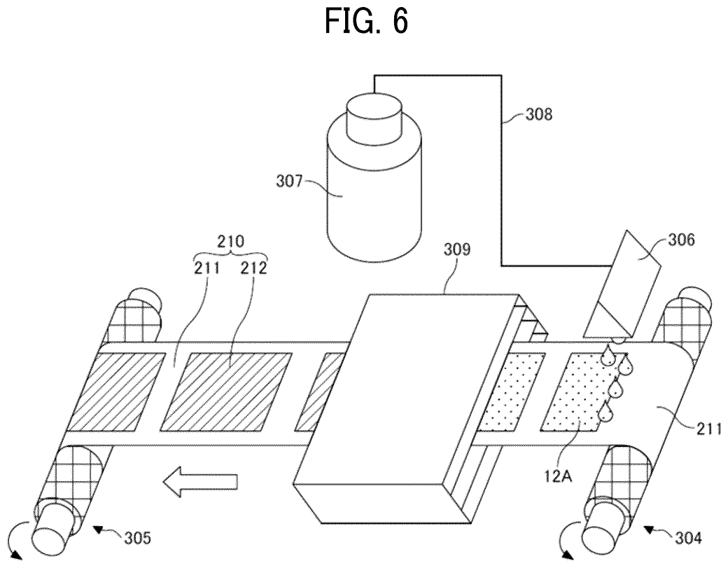

### FIG. 6

FIG. 6 is a schematic diagram illustrating the device (liquid discharging device) for manufacturing an electrode for an electrochemical element according to another embodiment of the present disclosure.

The method of manufacturing an electrode 210 for an electrochemical element, which has a structured layer formed on a substrate, includes a process of sequentially discharging a liquid composition 12A onto a first substrate 211 using the liquid discharging device 300′.

First, a slender first substrate 211 is prepared. The first substrate 211 is then wound around a cylindrical core, with the side where the structured layer 212 is to be formed facing upwards as illustrated in FIG. 6, and is placed between a feed roller 304 and a reeling roller 305. The feeding roller 304 and the reeling roller 305 rotate counterclockwise to convey the first substrate 211 from the right to left in FIG. 6. The liquid discharging head 306 disposed above the first substrate 211 between the feeding roller 304 and the reeling roller 305 discharges liquid droplets of the liquid composition 12A onto the first substrate 211 sequentially conveyed in the same manner as illustrated in FIG. 6.

Next, the first substrate 211, onto which the droplets of liquid composition 12A have been discharged, is conveyed to the polymerization unit 309 by the feed roller 304 and the reeling roller 305. As a result, the structured layer 212 is formed, and the electrode 210 for an electrochemical element, with the structured layer disposed on the substrate, is obtained. Thereafter, the electrode 210 is cut to a desired size by processing, such as punching.

Note that two or more of the liquid discharging heads 306 can be positioned in the direction substantially parallel or perpendicular to the conveyance direction of the first substrate 211.

The polymerization unit 309 may be installed on either the upper or lower side of the first substrate 211, or multiple units may be disposed.

The polymerization unit 309 is not particularly limited as long as it does not directly contact the liquid composition 12A. For example, in the case of thermal polymerization, options include resistance heating heaters, infrared heaters, and fan heaters, while in the case of photopolymerization, ultraviolet irradiation devices can be used.

There is no specific limitation to the conditions for heating or light irradiation. It can be selected to suit to a particular application. Due to polymerization, the liquid composition 12A is polymerized to form a structured layer.

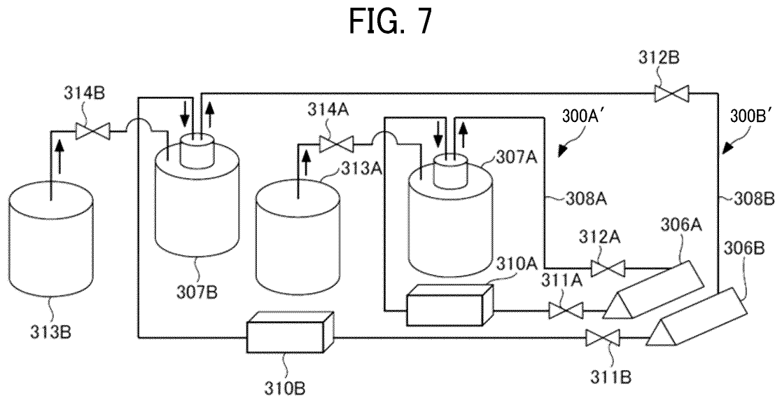

### FIG. 7

FIG. 7 is a schematic diagram illustrating a variation of the device for manufacturing an electrode for an electrochemical element according to an embodiment of the present disclosure.

The liquid discharging devices 300A′ and a 300B′ may be used in combination. Specifically, the liquid composition may be supplied from external tanks 313A and 313B connected to the tanks 307A and 307B, respectively, and the liquid discharging heads may include multiple heads 306A and 306B. Additionally, the system may include tubes 308A and 308B, valves 311A, 311B, 312A, 312B, 314A, and 314B, as well as pumps 310A and 310B.

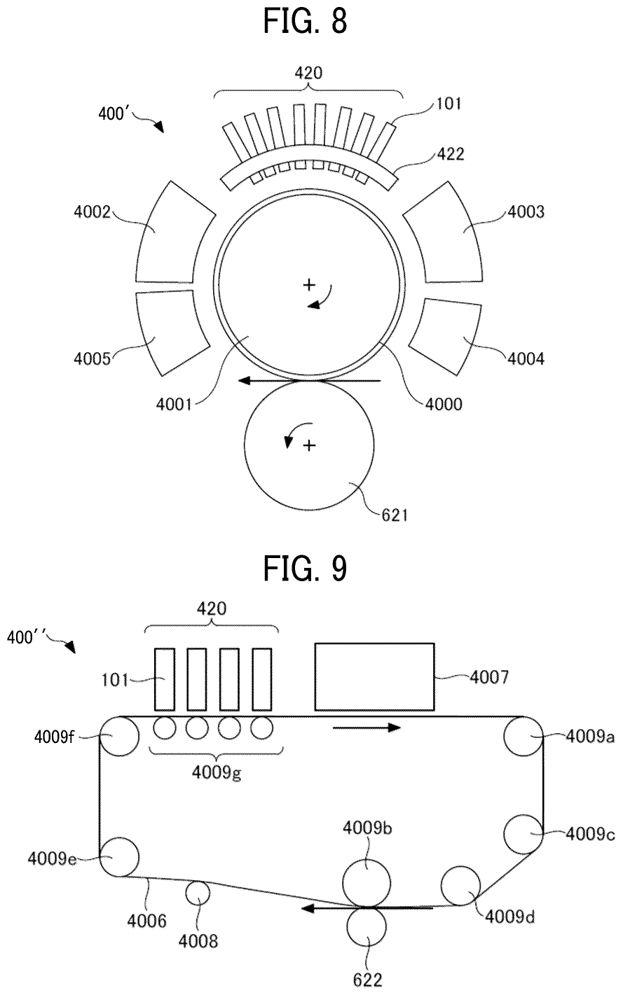

FIG. 8: Embodiments for Forming Structured Layer or Electrode for Electrochemical Element by Indirectly Applying Liquid Composition to Substrate

FIG. 8 is a diagram (part 1) illustrating a configuration of an example of the printing unit employing an inkjet method and transfer method as the liquid composition applying device in a device for manufacturing a member for an electrochemical element according to an embodiment of the present disclosure. In the printing unit illustrated in FIG. 8, a drum-shaped intermediate transfer body is used.

A printing unit 400′ is an inkjet printer that forms a structured layer on a substrate by transferring the liquid composition onto the substrate via an intermediate transfer member 4001.

The printing unit 400′ includes an inkjet unit 420, a transfer drum 4000, a pretreatment unit 4002, an absorption unit 4003, a heating unit 4004, and a cleaning unit 4005.

The inkjet unit 420 includes a head module 422 carrying multiple heads 101.

The heads 101 discharge a liquid composition to the intermediate transfer member 4001 supported by the transfer drum 4000 to form a liquid composition layer on the intermediate transfer member 4001. Each of the heads 101 is a line head. The nozzles thereof are disposed to cover the width of the printing region of the maximally usable substrate. The heads 101 have a nozzle surface formed with nozzles on its lower side, and the nozzle surface faces the surface of the intermediate transfer member 4001 through a minute gap. In the present embodiment, the intermediate transfer member 4001 is configured to move circularly on a circular orbit. The heads 101 are thus radially positioned.

The transfer drum 4000 faces an impression cylinder 621 and forms a transfer nip. The pretreatment unit 4002 may apply a reaction liquid to the intermediate transfer member 4001 to increase the viscosity of a liquid composition before the heads 101 discharge the liquid composition.

The absorption unit 4003 absorbs the liquid component from the liquid composition on the intermediate transfer member 4001 before transferring.

The heating unit 4004 heats the liquid composition on the intermediate transfer member 4001 before transferring. The structured layer is formed by heating the liquid composition. The solvent is also removed, thereby enhancing the transferability to the substrate.

The cleaning unit 4005 cleans the intermediate transfer member 4001 after the transfer process and removes ink and contaminants, such as dust, that remain on the intermediate transfer member 4001.

The outer surface of the impression cylinder 621 is in press contact with the intermediate transfer member 4001, allowing the structured layer on the intermediate transfer member 4001 to be transferred to the substrate when it passes through the transfer nip between the impression cylinder 621 and the intermediate transfer member 4001. The impression cylinder 621 can be configured to include at least one gripping mechanism for holding the front end of the substrate on its outer surface.

### FIG. 9

FIG. 9 is a diagram (part 2) illustrating a configuration of an example of the printing unit employing an inkjet method and transfer method as the device for applying the first liquid composition and the device for forming a polymerized compound layer of the second liquid composition in the device for manufacturing an electrode for an electrochemical element according to an embodiment of the present disclosure. The printing unit 9 has an intermediate transfer member having an endless belt form.

A printing unit 400″ is an inkjet printer that forms a structured layer by transferring the liquid composition onto a substrate via an intermediate transfer belt 4006.

The printing unit 400″ is equipped with an inkjet unit 420, a transfer roller 622, the intermediate transfer belt 4006, a heating unit 4007, a cleaning roller 4008, a drive roller 4009a, a counter roller 4009b, a shape-maintaining roller 4009c, a shape-maintaining roller 4009d, a shape-maintaining roller 4009e, and a shape-maintaining roller 4009f.

The printing unit 400″ discharges liquid droplets of the liquid composition from the heads 101 of the inkjet unit 420 onto the outer surface of the intermediate transfer belt 4006. The liquid composition on the intermediate transfer belt 4006 is heated by the heating unit 4007 and forms a structured layer through thermal polymerization. The structured layer on the intermediate transfer belt 4006 is transferred to the substrate at the transfer nip where the intermediate transfer belt 4006 faces the transfer roller 622. After transfer, the cleaning roller 4008 cleans the surface of the intermediate transfer belt 4006.

The intermediate transfer belt 4006 is stretched over a drive roller 4009a, a counter roller 4009b, multiple shape-maintaining rollers 4009c, 4009d, 4009e, 4009f, and several support rollers 4009g, and moves in the direction indicated by the arrow in FIG. 9. The support rollers 4009g disposed facing the heads 101 maintain the tension of the intermediate transfer belt 4006 when the heads 101 discharge the liquid composition.

### Electrode Laminate for Electrochemical Element

The electrode laminate for an electrochemical element of the present disclosure includes:
An electrode for an electrochemical element; and
A solid electrolyte layer, which is disposed on both the electrode composite layer and the structured layer.

Additionally, other components may be furthermore optionally included.

Since the electrode for an electrochemical element can adopt the configurations described in Electrode for Electrochemical Element, redundant descriptions are omitted.

An embodiment of the laminar electrode for an electrochemical element relating to the present disclosure is described with reference to the drawings. The present disclosure is not limited to these embodiments.

### FIG. 10

FIG. 10 is a schematic diagram illustrating a cross-sectional view of an electrode laminate for an electrochemical element according to an embodiment of the present disclosure.

An electrode laminate 35 for an electrochemical element includes:
The first substrate 21;
The electrode composite layer 20, disposed on the first substrate 21;
The structured layer 10, arranged at the outer peripheral of the electrode composite layer 20; and
A solid electrolyte layer 30, placed on both the electrode composite layer 20 and the structured layer 10.

In FIG. 10, a configuration is illustrated where the electrode composite layer 20, structured layer 10, and solid electrolyte layer 30 are disposed on one side of the first substrate 21. However, these layers may also be placed on both opposing sides of the first substrate 21.

Note that in FIG. 10, the laminated structure of the structured layer 10 is omitted.

### Solid Electrolyte Layer

There are no particular restrictions on the solid electrolyte, and it can be appropriately selected according to a particular application. The solid electrolyte described in Solid Electrolyte may be used.

The solid electrolyte layer is formed from a solid electrolyte layer forming liquid composition.

The solid electrolyte layer forming liquid composition may contain a binder for the solid electrolyte layer.

Examples include, but are not limited to, thermoplastic resins such as polyvinylidene fluoride (PVDF), acrylic resin, styrene-butadiene rubber, polyethylene, polypropylene, polyurethane, nylon, polytetrafluoroethylene, polyphenylene sulfide, polyethylene terephthalate, polybutylene terephthalate, polyamide compounds, polyimide compounds, polyamide-imide, ethylene-propylene-butadiene rubber (EPBR), styrene-butadiene rubber (SBR), nitrile-butadiene rubber (NBR), polymethyl methacrylate (PMMA), polybutyl methacrylate (PBMA), isoprene rubber, polyisobutene, polyethylene glycol (PEO), and polyethylene vinyl acetate (PEVA).

### Electrochemical Element

The electrochemical element of the present disclosure includes an electrode for an electrochemical element and may also optionally include external packaging and other components.

Since the electrode for an electrochemical element can adopt the configurations described in Electrode for Electrochemical Element, redundant descriptions are omitted.

### All Solid State Electrochemical Element

The electrochemical element of the present disclosure includes an electrode laminate for an electrochemical element and may also optionally include external packaging and other components.

Since the electrode laminate for an electrochemical element can adopt the configurations described in Electrode Laminate for Electrochemical Element, redundant descriptions are omitted.

An embodiment of the all solid state electrochemical element relating to the present disclosure is described with reference to the drawings. The present disclosure is not limited to these embodiments.

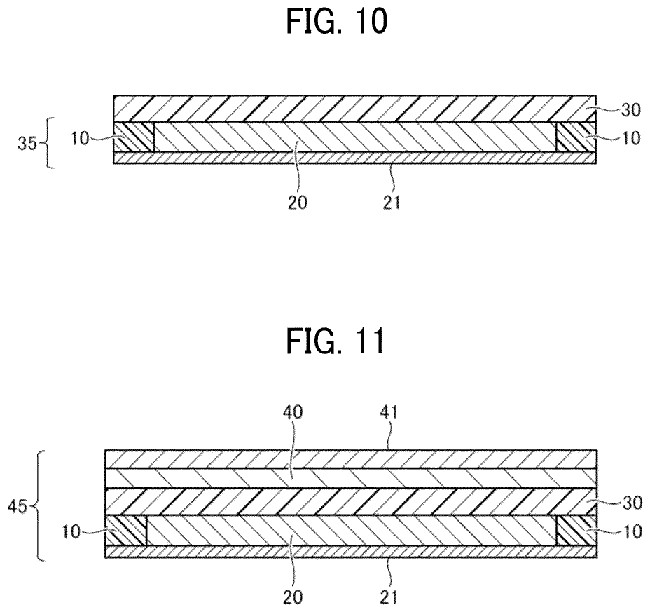

### FIG. 11

FIG. 11 is a schematic diagram illustrating a cross-sectional view of the all solid state electrochemical element according to an embodiment of the present disclosure.

An all solid state electrochemical element 45 includes:
The first substrate 21;
The electrode composite layer 20 disposed on the first substrate 21;
The structured layer 10 arranged at the outer peripheral of the electrode composite layer 20;
The solid electrolyte layer 30 placed on both the electrode composite layer 20 and the structured layer 10;
An electrode composite layer 40 arranged on the solid electrolyte layer 30; and
A second substrate 41 placed on the electrode composite layer 40.

The all solid state electrochemical element 45 is a single-cell layer, which can be laminated to form a stacked battery.

Note that FIG. 11 illustrates the configuration in which the electrode composite layer 20, structured layer 10, and solid electrolyte layer 30 are provided on one side of the first substrate 21, but the electrode composite layer 20, structured layer 10, and solid electrolyte layer 30 may be placed on both opposing sides of the first substrate 21. This configuration may be used as a stacked battery.

Note that in FIG. 11, the laminated structure of the structured layer 10 is omitted.

### FIG. 12

FIG. 12 is a schematic diagram illustrating a cross-sectional view of the all solid state electrochemical element according to an embodiment of the present disclosure.

The solid state battery illustrated in FIG. 12 includes a positive electrode (electrode composite layer) 20, a negative electrode (electrode composite layer) 40, a solid electrolyte layer 30, lead wires 50 and 51, and an outer casing 60.

The positive electrode (electrode composite layer) 20 includes:
A positive electrode substrate (substrate) 21;
A structured layer 10, which is arranged on the positive electrode substrate (substrate) 21 and at the outer peripheral of the positive electrode (electrode composite layer) 20. The lead wire 50 is connected to the positive electrode first substrate 21, and the lead wire 51 is connected to the negative electrode substrate (second substrate) 41. The lead wires 50 and 51 are drawn out to the outside of the outer casing 60.

In the all solid state electrochemical element, the positive electrode (electrode composite layer) 20 and the negative electrode (electrode composite layer) 40 are stacked via the solid electrolyte layer 30, and the positive electrode (electrode composite layer) 20 is disposed on both sides of the negative electrode (electrode composite layer) 40. Note that there is no particular limit on the number of stacks of the positive electrodes (electrode composite layer) 20 and the negative electrodes (electrode composite layer) 40. Also, the number of positive electrodes (electrode composite layers) 20 and negative electrodes (electrode composite layers) 40 may be the same or different.

Note that in FIG. 12, the laminated structure of the structured layer 10 is omitted.

As for the outer casing, there is no particular limitation as long as it can seal the electrode laminate, and a known outer casing can be appropriately selected depending on the purpose.

The shape of the electrochemical element is not particularly limited and can be appropriately selected depending on the purpose. For example, it may be a laminate type, cylinder type, or coin type.

### Method of Manufacturing Electrochemical Element and Apparatus for Manufacturing Electrochemical Element

The method of manufacturing an electrochemical element relating to the present disclosure preferably includes insulating layer formation, electrode composite layer formation, pressing, solid electrolyte layer formation, element formation, and electrode processing, and may furthermore include other optional processes.

The apparatus for manufacturing an electrochemical element relating to the present disclosure preferably includes an insulating layer forming device, an electrode composite layer forming device, a pressing device, a solid electrolyte layer forming device, an element forming device, and an electrode processing device, and may also include other optional devices.

The method of manufacturing an electrochemical element can be suitably carried out using the apparatus for manufacturing an electrochemical element.

### Insulating Layer Formation and Insulating Layer Forming Device

The insulating layer formation is to form an insulating layer on a substrate. The insulating layer formation preferably includes application of a liquid composition for forming an insulating layer, curing of a liquid composition for forming an insulating layer, and removal of a solvent.

The insulating layer forming device forms an insulating layer on a substrate. The insulating layer forming device preferably includes a device for applying a liquid composition for forming an insulating layer, a device for curing a liquid composition for forming an insulating layer, and a device for removing a solvent.

The insulating layer formation can be suitably carried out using the insulating layer forming device.

### Process of Applying Liquid Composition for Forming Insulating Layer and Device for Applying Liquid Composition for Forming Insulating Layer

In the process of applying a liquid composition for forming an insulating layer, a liquid composition for forming an insulating layer is applied to a substrate.

The device for applying a liquid composition for forming an insulating layer applies a liquid composition for forming an insulating layer to a substrate.

The process of applying a liquid composition for forming an insulating layer is suitably carried out using the device for applying a liquid composition for forming an insulating layer.

The liquid composition for forming an insulating layer can adopt the configurations described in Liquid Composition for Insulating Layer.

The process of applying a liquid composition for forming an insulating layer and the device for applying a liquid composition for forming an insulating layer can adopt the configurations described in First Liquid Composition Application and Device for Applying First Liquid Composition.

### Process of Polymerizing Liquid Composition for Forming Insulating Layer and Device for Polymerizing Liquid Composition for Forming Insulating Layer

In the process of polymerizing a liquid composition for forming an insulating layer, the liquid composition for forming an insulating layer that is applied is polymerized.

The device for polymerizing the liquid composition for forming the insulating layer polymerizes the liquid composition for forming an insulating layer that is applied.

The polymerization of a liquid composition for forming an insulating layer is suitably carried out using the device for polymerizing the liquid composition for forming the insulating layer.

Since the process of polymerizing a liquid composition for forming an insulating layer and the device for polymerizing a liquid composition for forming an insulating layer can adopt those described in Process of Forming polymerized compound layer of First Liquid Composition and Device for Forming Polymerized Compound Layer of First Liquid Composition.

### Process of Removal of Solvent and Device for Removing Solvent

In the process of removal of a solvent, the solvent is removed from the polymerized liquid composition for forming an insulating layer.

The device for removing a solvent removes the solvent from the polymerized liquid composition for forming an insulating layer.

The process of removal of a solvent and the device for removing a solvent can adopt those described in Process of Drying Polymerized Compound Layer of Liquid Composition and Device for Drying Polymerized Compound Layer of Liquid Composition.

### Process of Forming Electrode Composite Layer and Device for Forming Electrode Composite Layer

The process of forming an electrode composite layer is to form an electrode composite layer on a substrate.

The device for forming an electrode composite layer is to form an electrode composite layer on a substrate.

There are no particular limitations on the process of and the device for forming an electrode composite layer, and they can be appropriately selected according to a particular application. For example, one can use a method of applying a liquid composition for an electrode mixture layer onto conductive materials in a liquid, is applied onto a substrate, followed by fixing and drying. In this process, application methods such as spraying, dispensing, die coating, or dip coating can be suitably employed.

In the method of manufacturing an electrochemical element, there are no particular restrictions on the order of the insulating layer forming and the electrode composite layer forming. Specifically, the process of forming an electrode composite layer may be performed before the process of forming an insulating layer, with the insulating layer being formed around the outer periphery of the electrode composite layer after its formation. In this case, the method of manufacturing an electrochemical element involves performing the electrode composite layer formation, the insulating layer formation, and then the solvent removal in that order.

Similarly, the electrode composite layer may be formed after the insulating layer formation, with the insulating layer having a frame-like shape being formed around the outer periphery of the substrate, and then the electrode composite layer being formed inside the insulating layer. In this case, the method of manufacturing an electrochemical element involves performing the insulating layer formation, the electrode composite layer formation, and then the solvent removal in that order.

### Process of Forming Solid Electrolyte Layer and Device for Forming Solid Electrolyte Layer

The process of forming a solid electrolyte layer involves forming a solid electrolyte layer on both of the electrode composite layer and the insulating layer.

The device for forming a solid electrolyte layer involves forming a solid electrolyte layer on both of the electrode composite layer and the insulating layer.

The process of forming a solid electrolyte layer can be suitably carried out using device for forming a solid electrolyte layer.

There are no particular limitations on the method of and the device for forming the solid electrolyte layer, and it can be appropriately selected according to a particular application. For example, one way of forming the solid electrolyte involves applying a liquid composition for forming a solid electrolyte layer containing a solid electrolyte and an optional binder for a solid electrolyte layer, onto the electrode composite layer and the insulating layer, followed by drying through solidification.

The method of and the device for forming a solid electrolyte layer are not particularly limited and they can be suitably selected to suit to a particular application. Specific examples include, but are not limited to, liquid discharging methods such as an inkjet method, a spray coating method, and a dispenser method, spin coating, casting, MICROGRAVURE™ coating, gravure coating, bar coating, roll coating, wire bar coating, dip coating, slit coating, capillary coating, nozzle coating, gravure printing, screen printing, flexographic printing, offset printing, and reverse printing.

### Pressing Process and Pressing Device

The pressing process is to press the electrode composite layer and insulating layer.

The pressing device presses the electrode composite layer and insulating layer.

The pressing process is suitably executed by the pressing device.

Regarding the pressing process and device, there are no particular restrictions; it can be performed using commercially available pressure molding equipment. The electrode composite layer and the insulating layer are possibly pressed in the substrate direction. Examples include, but are not limited to, uniaxial presses, roll presses, cold isostatic presses (CIP), and hot presses. Among these, cold isostatic presses (CIP), which can apply isotropic pressure, are preferred.

There are no particular restrictions on the timing of the pressing process; it can be appropriately selected according to a particular application. For example, the electrode composite layer and the insulating layer can be pressed after being formed on the substrate, or the pressing can be done after the solid electrolyte layer has been provided, or at both timings if the thickness of the insulating layer before pressing are substantially equal to that of the electrode composite layer.

Carrying out the pressing process after forming the electrode composite layer and the insulating layer on the substrate, but before forming the solid electrolyte layer, makes the average thickness of the electrode composite layer and the average thickness of the insulating layer approximately equal. This sequence helps to distribute the pressure load, even if high pressure is applied during pressing the solid electrolyte layer provided on the electrode.

Regarding the pressing pressure, there are no particular restrictions, and it can be appropriately selected according to the objective; however, it is preferable to apply a pressure that enables the substrate and the electrode composite layer to be bonded and densification of the electrode composite layer at the same time. More specifically, a pressure between 1 MPa and 900 MPa is preferable, and a range between 50 MPa and 300 MPa is even more preferable.

Regarding the pressing device, there are no particular restrictions; it can be performed using commercially available pressure molding equipment. The electrode composite layer and the insulating layer are possibly pressed in the substrate direction. Examples include, but are not limited to, uniaxial presses, roll presses, cold isostatic presses (CIP), and hot presses. Among these, cold isostatic presses (CIP), which can apply isotropic pressure, are preferred.

The method of manufacturing an electrode laminate includes a series of the insulating layer formation to the pressing.

The device for manufacturing an electrode laminate includes each of the device for forming an insulating layer to the pressing device.

### Element Forming Process and Element Forming Device

The element forming process is for manufacturing an electrochemical element using an electrode laminate.

The element forming device is for manufacturing an electrochemical element using an electrode laminate.

There are no particular restrictions on the method of manufacturing an electrochemical element using an electrode laminate, and an appropriate, known method of manufacturing an electrochemical element may be selected according to a particular application. For example, it may include at least one of placing counter electrodes, winding or laminating, and housing in a container.

Note that the element forming process does not need to include all processes of element forming and may include only a part of the processes involved in element forming.

### Electrode Processing Process and Electrode Processing Device

The electrode processing process is for processing an electrode with a formed insulating layer, conducted after the application of the liquid composition for forming an insulating layer in the insulating layer formation. The electrode processing process may include at least one of a cutting process, folding process, and laminating process.

The electrode processing device is for processing an electrode with a formed insulating layer. The electrode processing device may include at least one of a cutting device, folding device, and laminating device.

The electrode processing device can cut the electrode with a formed insulating layer. The electrode processing device may, for example, wind or laminate the electrode with a formed insulating layer.

The electrode processing device may, for example, include an electrode processing device that performs cutting, accordion folding, laminating, or winding of the electrode with a formed insulating layer in accordance with the desired battery format.

The application of the electrochemical device is not particularly limited and it can be suitably selected to suit to a particular application.

Examples include, but are not limited to: mobile objects such as vehicles; and electric devices, such as mobile phones, notebook computers, pen-input personal computers, mobile personal computers, electronic book players, cellular phones, portable facsimiles, portable copiers, portable printers, headphone stereos, video movies, liquid crystal televisions, handy cleaners, portable compact discs (CDs), minidiscs, transceivers, electronic notebooks, calculators, memory cards, portable tape recorders, radios, backup power supplies, motors, lighting devices, toys, game machines, watches, strobes, and cameras. Of these, vehicles and electric devices are preferable.

The mobile objects include, but are not limited to, ordinary vehicles, heavy special cars, small special vehicles, trucks, heavy motorcycles, and ordinary motorcycles.

An embodiment of the mobile object as the electrochemical element relating to the present disclosure is described with reference to the drawings. The present disclosure is not limited to these embodiments.

### Mobile Object

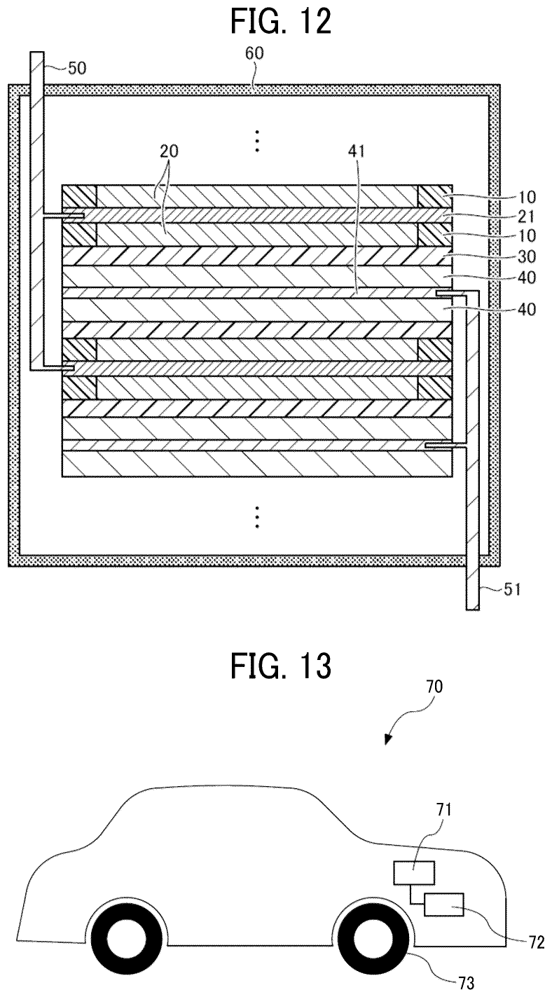

FIG. 13 is a schematic diagram illustrating a mobile object, which is an electrochemical element according to an embodiment of the present disclosure.

A mobile object 70 is an electric vehicle, for example. The mobile object 70 includes a motor 71, an electrochemical device 72, and wheels 73.

The electrochemical device 72 is an electrochemical device relating to the present disclosure. The electrochemical device 72 drives a motor 71 by supplying electricity to the motor 71. The motor 71 driven can drive the wheels 73, and as a result, the mobile object 70 can move.

Since the mobile object 70 is equipped with the electrochemical device 72, it prevents short circuits between the positive and negative electrodes, and is driven by the power from an electrochemical device that has excellent battery properties, allowing the vehicle to move safely and efficiently.

The mobile object 70 is not limited to an electric vehicle; it may be a plug-in hybrid vehicle (PHEV), a hybrid electric vehicle (HEV), and a locomotive or motorcycle that can operate using both a diesel engine and an electrochemical element. Additionally, the mobile object 70 could be a transport robot used in factories, capable of operating with only an electrochemical element or in combination with an engine and an electrochemical element. Furthermore, the mobile object 70 could be a device where not the entire object moves, but only a part of it, such as an assembly robot placed in a factory production line, which can operate using only an electrochemical element or in combination with an engine and an electrochemical element to move an arm or other components.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples and Comparative Examples but is not limited thereto. In the following Examples and Comparative Examples, “parts” represents “parts by mass” and, “percent”, “percent by mass”, unless otherwise specified.

### Preparation of Liquid Composition 1

A liquid composition 1 was prepared by:

Admixing 50 percent by mass polyethylene glycol (200) diacrylate (trade name: PEG200DA, available from Daicel Ordnance Co., Ltd.) as a polymerizable compound with 24 percent by mass menthane and 26 percent by mass diethylene glycol diethyl ether as solvents (solvent mass ratio 48:52); and

Mixing the mixture obtained with bis(2,4,6-trimethylbenzoyl)phenyl phosphate as a polymerization initiator at 1 percent by mass to the polymerizable compound.

### Preparation of Liquid Composition 2

A liquid composition 2 was prepared by:

Admixing 25 percent by mass CN2283 and 25 percent by mass HPPA as polymerizable compounds with 38.5 percent by mass decane and 11.5 percent by mass 2-ethylhexyl acetate as solvents (solvent mass ratio 77:23); and

Mixing the mixture obtained with bis(2,4,6-trimethylbenzoyl)phenyl phosphate as a polymerization initiator at 1 percent by mass to the polymerizable compound.

### Preparation of Liquid Composition 3

A liquid composition 3 was prepared by:

Admixing 50 percent by mass polyethylene glycol (200) diacrylate (trade name: PEG200DA, available from Daicel Ordnance Co., Ltd.) as a polymerizable compound with 50 percent by mass diethylene glycol diethyl ether as a solvent; and

Mixing the mixture obtained with bis(2,4,6-trimethylbenzoyl)phenyl phosphate as a polymerization initiator at 1 percent by mass to the polymerizable compound.

### Preparation of Liquid Composition 4

A liquid composition 4 was prepared by:

Admixing 50 percent by mass polyethylene glycol (200) diacrylate (trade name: PEG200DA, available from Daicel Ordnance Co., Ltd.) as a polymerizable compound with 6 percent by mass menthane and 44 percent by mass diethylene glycol diethyl ether as solvents; and

Mixing the mixture obtained with bis(2,4,6-trimethylbenzoyl)phenyl phosphate as a polymerization initiator at 1 percent by mass to the polymerizable compound.

### Preparation of Liquid Composition 5

A liquid composition 5 was prepared by:

Admixing 35 percent by mass polyethylene glycol (200) diacrylate (trade name: PEG200DA, available from Daicel Ordnance Co., Ltd.) as a polymerizable compound with 31.2 percent by mass menthane and 33.8 percent by mass diethylene glycol diethyl ether as solvents (solvent mass ratio 48:52); and

Mixing the mixture obtained with bis(2,4,6-trimethylbenzoyl)phenyl phosphate as a polymerization initiator at 1 percent by mass to the polymerizable compound.

### Preparation of Liquid Composition 6

A liquid composition 6 was prepared by:

Admixing 100 percent by mass polyethylene glycol (200) diacrylate (trade name: PEG200DA, available from Daicel Ordnance Co., Ltd.) as a polymerizable compound with bis(2,4,6-trimethylbenzoyl) phenyl phosphate as a polymerization initiator at 1 percent by mass to the polymerizable compound.

TABLE 1

| | Insoluble | | | | | | |
|---|---|---|---|---|---|---|---|
| | polymerizable | | | | | | |
| | compound | | Soluble | | | | |
| | | Mass | polymerizable | | | | |
| | | ratio | compound | | Solvent | Poor solvent | |
| Liquid | | (mixing | | Mass | soluble | | Mass |
| composition | Type | ratio Y) | Type | ratio | point | Type | ratio |
| 1 | PEG200DA | 1 | — | — | — | Menthane | 0.48 |
| 2 | CN2283NS | 0.5 | HPP-A | 0.5 | 50 | Decane | 0.77 |
| 3 | PEG200DA | 1 | — | — | — | — | — |
| 4 | PEG200DA | 1 | — | — | — | Menthane | 0.12 |
| 5 | PEG200DA | 1 | — | — | — | Menthane | 0.48 |

| | Good solvent | | | | |
|---|---|---|---|---|---|
| | | Mass | | | |
| | | ratio | Polymerizable | Mixing ratio | |
| Liquid | | (mixing | compound | (polymerizable | Solid |
| composition | Type | ratio X) | soluble point | compound:solvent) | portion |
| 1 | Diethylene | 0.52 | 52 | 50:50 | 0.50 |
| | glycol | | | | |
| | diethyl | | | | |
| | ether | | | | |
| 2 | 2- | 0.23 | 23 | 50:50 | 0.50 |
| | Ethylhexyl | | | | |
| | acetate | | | | |
| 3 | Diethylene | 1 | — | 50:50 | 0.50 |
| | glycol | | | | |
| | diethyl | | | | |
| | ether | | | | |
| 4 | Diethylene | 0.88 | 76 | 50:50 | 0.50 |
| | glycol | | | | |
| | diethyl | | | | |
| | ether | | | | |
| 5 | Diethylene | 0.52 | 52 | 35:65 | 0.35 |
| | glycol | | | | |
| | diethyl | | | | |
| | ether | | | | |

### Example 1

### Preparation of Electrode for Electrochemical Element

The liquid composition 1 obtained was filled into an inkjet dispensing device equipped with MH5421F (available from Ricoh Co., Ltd.).

Using an inkjet device, the liquid composition 1 was applied to one side of an aluminum foil substrate (50 mm×50 mm, average thickness: 15 μm) in a shape with an intended film thickness of 10 μm and dimensions of 50 mm×30 mm. One second after application, the coated area was irradiated with ultraviolet (UV) (light source: UV-LED, product name: FJ800, available from Phoseon Technology, wavelength: 365 nm, irradiation intensity: 30 mW/cm², irradiation time: 20 s), followed by curing the resulting material to obtain a polymerized composition layer of the first liquid composition.

After UV irradiation, the same liquid composition 1 was reapplied to the same coating area with an intended film thickness of 140 μm. Similarly, UV irradiation was performed one second after application to cure the resulting material, obtaining a polymerized composition layer of the second liquid composition.

Subsequently, the coated sample was heated at 120 degrees Celsius for 10 minutes using a hot plate to remove the solvent, yielding Electrode 1 for an electrochemical device of Example 1 with an average thickness of 150 um.

### Measurement of Average Thickness of Each Layer

The cross-sectional observation of Electrode 1 for an electrochemical device was conducted using a scanning electron microscope (SEM) (Phenom Pro-X, available from JASCO INTERNATIONAL CO., LTD.).

The average thickness of the polymerized composition layer of the first liquid composition was determined by measuring the thickness at three or more points with reference to the substrate surface and then calculating the average of the measured values.

The average thickness of the polymerized composition layer of the second liquid composition was determined by measuring the thickness at three or more points with reference to the interface between the polymerized composition layers of the first and second liquid compositions, and then calculating the average of the measured values.

If polymerized composition layers of third or subsequent liquid compositions were present, their thickness was measured in the same manner.

The total thickness (average thickness) of the polymerized composition layers of the liquid compositions was determined by measuring the total thickness at three or more points with reference to the substrate surface and then calculating the average of the measured values. The results are shown in Table 2.

### Measurement of Porosity

Initially the insulating resin layer was osmium stained and then subjected to vacuum impregnation with epoxy resin. The internal cross-section structure is then cut out using a focused ion beam (FIB) and observed using a scanning electron microscope (SEM). The results are shown in Table 2.

### Evaluation on Uncontrolled Spreading

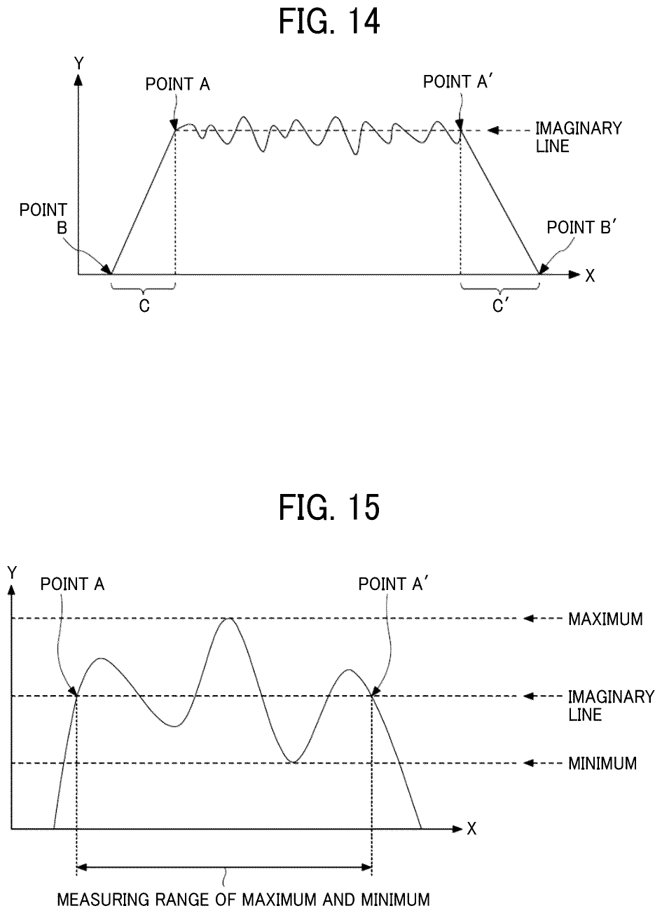

The method of evaluating uncontrolled spreading is explained using FIG. 14.

The shape of the electrode for an electrochemical device was measured using a laser microscope (VKX-3000, available from KEYENCE CORPORATION). The Y-axis represents the thickness of the polymerized composition layer of the liquid composition, while the X-axis (Y=0) corresponds to the substrate surface. Based on the total thickness (average thickness) obtained from Measurement of Average Thickness of Each Layer, an imaginary line was drawn parallel to the X-axis. The intersection points between this imaginary line and one end of the upper surface of the polymerized composition layer of the liquid composition were defined as points A and A′. Additionally, the intersection points between the polymerized composition layer of the liquid composition and the X-axis were defined as points B and B′. The horizontal distance between points A and B was defined as the taper length C, and the horizontal distance between points A′ and B′ was defined as the taper length C′. The average value of taper lengths C and C′ was then calculated and evaluated based on the evaluation criteria below. A smaller taper length indicates a superior uncontrolled spreading suppression effect. The results are shown in Table 2.

### Evaluation Criteria

A: The average of the taper lengths is at most 5 mm
C: The average of the taper lengths is greater than 5 mm

### Evaluation on Flatness

The evaluation method of evaluating flatness is explained using FIG. 15.

The shape of the electrode for an electrochemical device was measured using a laser microscope (VKX-3000, available from KEYENCE CORPORATION). The Y-axis represents the thickness of the polymerized composition layer of the liquid composition, while the X-axis (Y=0) corresponds to the substrate surface. Based on the total thickness (average thickness) obtained from Measurement of Average Thickness of Each Layer, an imaginary line was drawn parallel to the X-axis. The intersection points between this imaginary line and both ends of the upper surface of the polymerized composition layer of the liquid composition were defined as points A and A′. The maximum thickness and minimum thickness within the measurement range between points A and A′ were measured. The difference between the obtained maximum and minimum thickness values was calculated and evaluated based on the evaluation criteria below. A rating of B or higher was considered as passing. The results are shown in Table 2.

### Evaluation Criteria

A: Difference is less than 5 μm
B: Difference is 5 to less than 10 μm
C: Difference is at least 10 μm

### Evaluation on Curling

With the electrode for the electrochemical device placed on a horizontal surface, the maximum height (mm) of the lifted edge at one end of the electrode was measured as “warpage” and evaluated based on the evaluation criteria below. A rating of B or higher was considered as passing. The results are shown in Table 2.

### Evaluation Criteria

S: Maximum warpage is 0 to less than 1 mm
A: Maximum warpage is 1 to less than 3 mm
B: Maximum warpage is 3 to less than 5 mm
C: Maximum warpage is at least 5 mm

### Evaluation on Peeling Resistance

The substrate surface of Electrode 1 for an electrochemical element was caused to adhere to a stainless steel plate, and one end of the tape was attached to a force gauge (ZTA-5N, available from IMADA Co., Ltd.). The opposite end of the tape attached to the force gauge was caused to adhere to the polymerized layer of the liquid composition on the electrode for an electrochemical element, and the 90-degree peel resistance was measured. The evaluation was made according to the evaluation criteria below. A rating of B or higher was considered as passing. The results are shown in Table 2.

### Evaluation Criteria

A: Resistance to peeling is at least 100 N/m
B: Resistance to peeling is 30 to less than 100 N/m
C: Resistance to peeling is less than 100 N/m

### Examples 2 to 5

The Electrodes of Example 2 to 5 were prepared in the same manner as in Example 1 except that the conditions were changes to those shown in Table 2 and were subjected to each measurement and evaluation. The results are shown in Table 2.

### Example 6

The liquid composition 3 obtained was filled into an inkjet discharging device equipped with MH5421F (available from Ricoh Co., Ltd.).

Using an inkjet device, the liquid composition 3 was applied to one side of an aluminum foil substrate (50 mm×50 mm, average thickness: 15 μm) in a shape with an intended film thickness of 10 μm and dimensions of 50 mm×30 mm. One second after application, the coated area was irradiated with ultraviolet (UV) (light source: UV-LED, product name: FJ800, available from Phoseon Technology, wavelength: 365 nm, irradiation intensity: 30 mW/cm², irradiation time: 20 s), followed by curing the resulting material to obtain a polymerized composition layer of the first liquid composition.

After UV irradiation, the same liquid composition 3 was reapplied to the same coating area with an intended film thickness of 45 μm. Similarly, UV irradiation was performed one second after application to cure the resulting material, obtaining a polymerized composition layer of the second liquid composition.

After UV irradiation, the same liquid composition 3 was reapplied to the same coating area with an intended film thickness of 95 μm. Similarly, UV irradiation was performed one second after application to cure the resulting material, obtaining a polymerized composition layer of the third liquid composition.

Subsequently, the coated sample was heated at 120 degrees Celsius for 10 minutes using a hot plate to remove the solvent, yielding Electrode 6 for an electrochemical device of Example 6 with an average thickness of 150 μm.

### Examples 7 to 22

The Electrodes of Example 7 to 22 were prepared in the same manner as in Example 1 except that the conditions were changes to those shown in Table 2 and were then subjected to each measurement and evaluation. The results are shown in Table 2.

In Examples 14 and 15, a copper foil substrate (50 mm×50 mm, average thickness: 15 μm) was used as the substrate, while in Examples 16 and 17, a stainless steel foil substrate (50 mm×50 mm, average thickness: 15 μm) was used as the substrate.

### Comparative Example 1

The liquid composition 1 obtained was filled into an inkjet discharging device equipped with MH5421F (available from Ricoh Co., Ltd.).

Using an inkjet device, the liquid composition 1 was applied to one side of an aluminum foil substrate (50 mm×50 mm, average thickness: 15 μm) in a shape with an intended film thickness of 150 μm and dimensions of 50 mm×30 mm. One second after application, the coated area was irradiated with ultraviolet (UV) (light source: UV-LED, product name: FJ800, available from Phoseon Technology, wavelength: 365 nm, irradiation intensity: 30 mW/cm², irradiation time: 20 s), followed by curing the resulting material to obtain a polymerized composition layer of the first liquid composition.

Subsequently, the coated sample was heated at 120 degrees Celsius for 10 minutes using a hot plate to remove the solvent, yielding Comparative Electrode 1 for an electrochemical device of Comparative Example 1 with an average thickness of 150 um.

### Comparative Examples 2 to 3

The Electrodes of Comparative Example 2 and 3 were prepared in the same manner as in Comparative Example 1 except that the conditions were changes to those shown in Table 2 and then were subjected to each measurement and evaluation. The results are shown in

TABLE 2

| | | Layer of first liquid composition | | | Layer of second liquid composition | | |
|---|---|---|---|---|---|---|---|
| | | | Average | | Second | Average | |
| | | First liquid | thickness | Porosity | liquid | thickness | Porosity |
| Table 2 | Substrate | composition | (μm) | (percent) | composition | (μm) | (percent) |
| Example 1 | Aluminum | Liquid | 10 | 50 | Liquid | 140 | 51 |
| | | composition | | | composition | | |
| | | 1 | | | 1 | | |
| Example 2 | Aluminum | Liquid | 8 | 48 | Liquid | 142 | 51 |
| | | composition | | | composition | | |
| | | 1 | | | 1 | | |
| Example 3 | Aluminum | Liquid | 55 | 51 | Liquid | 95 | 51 |
| | | composition | | | composition | | |
| | | 1 | | | 1 | | |
| Example 4 | Aluminum | Liquid | 10 | 55 | Liquid | 140 | 56 |
| | | composition | | | composition | | |
| | | 2 | | | 2 | | |
| Example 5 | Aluminum | Liquid | 10 | 54 | Liquid | 140 | 55 |
| | | composition | | | composition | | |
| | | 3 | | | 3 | | |
| Example 6 | Aluminum | Liquid | 10 | 50 | Liquid | 45 | 51 |
| | | composition | | | composition | | |
| | | 1 | | | 1 | | |
| Example 7 | Aluminum | Liquid | 10 | 51 | Liquid | 10 | 51 |
| | | composition | | | composition | | |
| | | 1 | | | 1 | | |
| Example 8 | Aluminum | Liquid | 10 | 51 | Liquid | 100 | 50 |
| | | composition | | | composition | | |
| | | 1 | | | 1 | | |
| Example 9 | Aluminum | Liquid | 10 | 50 | Liquid | 100 | 51 |
| | | composition | | | composition | | |
| | | 1 | | | 1 | | |
| Example 10 | Aluminum | Liquid | 10 | 51 | Liquid | 140 | 51 |
| | | composition | | | composition | | |
| | | 4 | | | 4 | | |
| Example 11 | Aluminum | Liquid | 10 | 51 | Liquid | 140 | 52 |
| | | composition | | | composition | | |
| | | 1 | | | 1 | | |
| Example 12 | Aluminum | Liquid | 10 | 51 | Liquid | 100 | 51 |
| | | composition | | | composition | | |
| | | 1 | | | 1 | | |
| Example 13 | Aluminum | Liquid | 10 | 72 | Liquid | 140 | 51 |
| | | composition | | | composition | | |
| | | 5 | | | 1 | | |
| Example 14 | Copper | Liquid | 10 | 51 | Liquid | 140 | 51 |
| | | composition | | | composition | | |
| | | 1 | | | 1 | | |
| Example 15 | Copper | Liquid | 10 | 56 | Liquid | 140 | 56 |
| | | composition | | | composition | | |
| | | 2 | | | 2 | | |
| Example 16 | SUS | Liquid | 10 | 51 | Liquid | 140 | 51 |
| | (bipolar) | composition | | | composition | | |
| | | 1 | | | 1 | | |
| Example 17 | SUS | Liquid | 10 | 55 | Liquid | 140 | 56 |
| | (bipolar) | composition | | | composition | | |
| | | 2 | | | 2 | | |
| Example 18 | Aluminum | Liquid | 10 | | Liquid | 130 | 51 |
| | | composition | | | composition | | |
| | | 1 | | | 1 | | |
| Example 19 | Aluminum | Liquid | 10 | 51 | Liquid | 100 | 52 |
| | | composition | | | composition | | |
| | | 1 | | | 1 | | |
| Example 20 | Aluminum | Liquid | 10 | 51 | Liquid | 95 | 51 |
| | | composition | | | composition | | |
| | | 1 | | | 1 | | |
| Example 21 | Aluminum | Liquid | 8 | 48 | Liquid | 95 | 51 |
| | | composition | | | composition | | |
| | | 1 | | | 1 | | |
| Example 22 | Aluminum | Liquid | 8 | 47 | Liquid | 100 | 51 |
| | | composition | | | composition | | |
| | | 1 | | | 1 | | |
| Comparative | Aluminum | Liquid | 150 | 51 | — | — | — |
| Example 1 | | composition | | | | | |
| | | 1 | | | | | |
| Comparative | Aluminum | Liquid | 110 | 51 | — | — | — |
| Example 2 | | composition | | | | | |
| | | 1 | | | | | |
| Comparative | Aluminum | Liquid | 150 | 100 | — | — | — |
| Example 3 | | composition | | | | | |
| | | 6 | | | | | |

| | | Layer of third liquid composition | | | | Timing of |
|---|---|---|---|---|---|---|
| | | | Average | | Total | drying layer |
| | | Third liquid | thickness | Porosity | thickness | of liquid |
| Table 2 | Substrate | composition | (μm) | (percent) | (μm) | composition |
| Example 1 | Aluminum | — | — | — | 150 | After |
| | | | | | | second |
| | | | | | | layer |
| | | | | | | formation |
| Example 2 | Aluminum | — | — | — | 150 | After |
| | | | | | | second |
| | | | | | | layer |
| | | | | | | formation |
| Example 3 | Aluminum | — | — | — | 150 | After |
| | | | | | | second |
| | | | | | | layer |
| | | | | | | formation |
| Example 4 | Aluminum | — | — | — | 150 | After |
| | | | | | | second |
| | | | | | | layer |
| | | | | | | formation |
| Example 5 | Aluminum | — | — | — | 150 | After |
| | | | | | | second |
| | | | | | | layer |
| | | | | | | formation |
| Example 6 | Aluminum | Liquid | 95 | 51 | 150 | After third |
| | | composition | | | | layer |
| | | 1 | | | | formation |
| Example 7 | Aluminum | Liquid | 130 | 51 | 150 | After third |
| | | composition | | | | layer |
| | | 1 | | | | formation |
| Example 8 | Aluminum | Liquid | 40 | 51 | 150 | After third |
| | | composition | | | | layer |
| | | 1 | | | | formation |
| Example 9 | Aluminum | Liquid | 100 | 51 | 210 | After third |
| | | composition | | | | layer |
| | | 1 | | | | formation |
| Example 10 | Aluminum | — | — | — | 150 | After |
| | | | | | | second |
| | | | | | | layer |
| | | | | | | formation |
| Example 11 | Aluminum | — | — | — | 150 | After or in |
| | | | | | | the middle |
| | | | | | | of first layer |
| | | | | | | formation |
| Example 12 | Aluminum | Liquid | 100 | 51 | 210 | After or in |
| | | composition | | | | the middle |
| | | 1 | | | | of second |
| | | | | | | layer |
| | | | | | | formation |
| Example 13 | Aluminum | — | — | — | 150 | After |
| | | | | | | second |
| | | | | | | layer |
| | | | | | | formation |
| Example 14 | Copper | — | — | — | 150 | After |
| | | | | | | second |
| | | | | | | layer |
| | | | | | | formation |
| Example 15 | Copper | — | — | — | 150 | After |
| | | | | | | second |
| | | | | | | layer |
| | | | | | | formation |
| Example 16 | SUS (bipolar) | — | — | — | 150 | After |
| | | | | | | second |
| | | | | | | layer |
| | | | | | | formation |
| Example 17 | SUS (bipolar) | — | — | — | 150 | After |
| | | | | | | second |
| | | | | | | layer |
| | | | | | | formation |
| Example 18 | Aluminum | — | — | — | 140 | After |
| | | | | | | second |
| | | | | | | layer |
| | | | | | | formation |
| Example 19 | Aluminum | — | — | — | 110 | After |
| | | | | | | second |
| | | | | | | layer |
| | | | | | | formation |
| Example 20 | Aluminum | — | — | — | 105 | After |
| | | | | | | second |
| | | | | | | layer |
| | | | | | | formation |
| Example 21 | Aluminum | — | — | — | 103 | After |
| | | | | | | second |
| | | | | | | layer |
| | | | | | | formation |
| Example 22 | Aluminum | — | — | — | 108 | After |
| | | | | | | second |
| | | | | | | layer |
| | | | | | | formation |
| Comparative | Aluminum | — | — | — | — | After first |
| Example 1 | | | | | | layer |
| | | | | | | formation |
| Comparative | Aluminum | — | — | — | — | After first |
| Example 2 | | | | | | layer |
| | | | | | | formation |
| Comparative | Aluminum | — | — | — | — | — |
| Example 3 | | | | | | |

| | | Evaluation on uncontrolled | | | | Evaluation |
|---|---|---|---|---|---|---|
| | | spreading | | Evaluation | Evaluation | on peeling |
| Table 2 | Substrate | Taper length | Evaluation | on flatness | on curling | resistance |
| Example 1 | Aluminum | 4.5 | A | A | A | A |
| Example 2 | Aluminum | 4.4 | A | A | B | A |
| Example 3 | Aluminum | 4.8 | A | B | A | A |
| Example 4 | Aluminum | 4.5 | A | A | A | A |
| Example 5 | Aluminum | 4.5 | A | A | B | B |
| Example 6 | Aluminum | 4.4 | A | B | A | A |
| Example 7 | Aluminum | 4.5 | A | B | A | A |
| Example 8 | Aluminum | 4.5 | A | B | A | A |
| Example 9 | Aluminum | 5 | A | A | A | A |
| Example 10 | Aluminum | 4.5 | A | A | B | B |
| Example 11 | Aluminum | 4.5 | A | B | A | A |
| Example 12 | Aluminum | 4.5 | A | B | A | A |
| Example 13 | Aluminum | 4.5 | A | A | A | B |
| Example 14 | Copper | 4.5 | A | A | A | A |
| Example 15 | Copper | 4.5 | A | A | A | A |
| Example 16 | SUS (bipolar) | 4.5 | A | A | A | A |
| Example 17 | SUS (bipolar) | 4.5 | A | A | A | A |
| Example 18 | Aluminum | 4.3 | A | A | A | A |
| Example 19 | Aluminum | 4.2 | A | A | A | A |
| Example 20 | Aluminum | 4.2 | A | B | A | A |
| Example 21 | Aluminum | 4.1 | A | B | B | A |
| Example 22 | Aluminum | 4.2 | A | A | B | A |
| Comparative | Aluminum | 7 | C | A | A | A |
| Example 1 | | | | | | |
| Comparative | Aluminum | 6.5 | C | A | A | A |
| Example 2 | | | | | | |
| Comparative | Aluminum | — | — | — | C | — |
| Example 3 | | | | | | |

As seen in the results of Examples 1 to 22 shown in Table 2, an excellent suppression effect on uncontrolled spreading is achieved.

As seen in the results of Examples 2, 21, and 22, a sufficient suppression effect on uncontrolled spreading is not achieved if the average thickness of the polymerized layer of the first liquid composition is less than 10 μm.

As seen in the results of Examples 3, 6, 7, 8, 20, and 21, it is found that flatness is lost and a coffee ring effect occurs when the average thickness of the polymerized layer of the second liquid composition and the polymerized layer of the third liquid composition is less than 100 μm.

As seen in the results of Examples 5 and 10, in the case of the liquid compositions 3 to 4, which do not satisfy either Relationship 1 or Relationship 2, sufficient curl suppression effect and sufficient peel resistance are not obtained.

As seen in the result of Example 11, if the process of drying the polymerized layer of the liquid composition is performed before or in the middle of the second liquid composition application, flatness is lost, and a coffee ring effect occurs.

As seen in the result of Example 12, if the process of drying the polymerized layer of the liquid composition is performed before or in the middle of the third liquid composition application, flatness is lost, and a coffee ring effect occurs.

As seen in the result of Example 13, when the low-polymerizable-compound-content liquid composition 5 is used as the first liquid composition, the peel resistance decreases.

Since the polymerized layer of the second liquid composition is not formed in Comparative Examples 1 and 2, a sufficient suppression effect on uncontrolled spreading is not achieved.

The liquid composition 6 did not form a porous structure in Comparative Example 3, curling occurred, and various evaluations could not be performed.

Aspects of the present disclosure include, but are not limited to the following:

### Aspect 1

A method of manufacturing an electrode for an electrochemical element includes forming a structured layer including applying a first liquid composition containing a first polymerizable compound and a first solvent onto a substrate, polymerizing the first liquid composition applied in the applying the first liquid composition to form a first polymerized compound layer of the first liquid composition with a porous structure, and applying a second liquid composition containing a second polymerizable compound and a second solvent onto the first polymerized compound layer to manufacture the electrode including a substrate, an electrode composite layer disposed on the substrate, the structured layer disposed on at least a part of the outer periphery of the electrode composite layer.

### Aspect 2

The method according to Aspect 1 mentioned above further includes polymerizing the second liquid composition to form a second polymerized compound layer of the second liquid composition.

### Aspect 3

The method according to Aspect 2 mentioned above, further includes drying the first polymerized compound layer and the second polymerized compound layer.

### Aspect 4

The method according to any one of Aspects 1 to 3 mentioned above, wherein the first polymerized compound layer has an average thickness of at least 10 μm.

### Aspect 5

The method according to any one of Aspects 2 to 4 mentioned above, wherein the second polymerized compound layer has a single-layered structure.

### Aspect 6

The method according to any one of Aspects 2 to 4 mentioned above, wherein the second polymerized compound layer has a multi-layered structure of at least two layers.

### Aspect 7

The method according to any one of Aspects 2 to 6 mentioned above, wherein at least one layer of the second polymerized compound layer has an average thickness of at least 100 μm.

### Aspect 8

The method according to any one of Aspects 1 to 7 mentioned above, wherein the first polymerizable compound is represented by the following Chemical Formula 1 or Chemical Formula 2.

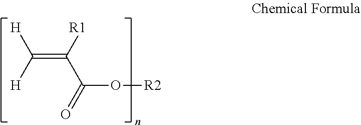

In Chemical Formula 1, R1 represents a hydrogen atom or a methyl group, R2 represents a hydrocarbon chain, an alkylene oxide chain, a polyester chain, or an acrylic oligomer ester derivative, and n represents an integer of from 2 to 6.

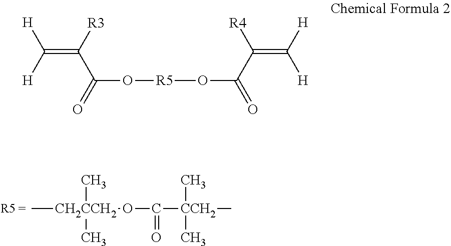

In Chemical Formula 2, R3 and R4 each, independently, represent hydrogen atoms or methyl groups.

### Aspect 9

The method according to any one of Aspects 1 to 3 mentioned above, wherein the first solvent is a solvent mixture of a good solvent in which the first polymerizable compound is soluble and a poor solvent in which the first polymerizable compound is insoluble and satisfies the following Relationship 1

$$Polymerizable compound soluble point \leq Mixing ratio X < Polymerizable compound soluble point + 11 \qquad Relationship 1$$

where the mixing ratio X represents a content ratio by percentage based on a mass of the good solvent in the solvent mixture, and the polymerizable compound soluble point represents a minimum content ratio by percentage based on the mass of the good solvent in the solvent mixture.

### Aspect 10

The method according to any one of Aspects 1 to 9 mentioned above, wherein the first polymerizable compound is a compound mixture containing a soluble polymerizable compound soluble in the first solvent and an insoluble polymerizable compound insoluble in the first solvent, and the first polymerizable compound satisfies the following Relationship 2,

$$Polymerizable compound soluble point \leq Mixing ratio X < Polymerizable compound soluble point + 11 \qquad Relationship 2$$

where the mixing ratio Y represents a content ratio by percentage based on a mass of the insoluble polymerizable compound in the compound mixture, and the solvent soluble point represents a minimum content ratio by percentage based on the mass of the insoluble polymerizable compound in the compound mixture.

### Aspect 11

The method according to any one of Aspects 1 to 10 mentioned above, wherein the first solvent contains a porogen.

### Aspect 12

The method according to any one of Aspects 1 to 11 mentioned above, wherein the first polymerized compound layer has a co-continuous structure with a resin framework.

### Aspect 13

The method according to any one of Aspects 1 to 3 mentioned above, wherein the applying the first liquid composition further includes applying the first liquid composition onto the substrate and the outer periphery of the electrode composite layer, and the applying the first liquid composition and the applying the second liquid composition are carried out by inkjetting, and the electrode composite layer contains an active material.

### Aspect 14

An electrode for an electrochemical element includes a substrate, an electrode composite layer disposed on the substrate, and a structure layer disposed on at least a part of the outer periphery of the electrode composite layer, wherein the structure layer includes a laminar structure of at least two layers including a first structure layer in contact with the substrate and a second structure layer disposed on the first structure layer.

### Aspect 15

An electrode for an electrochemical element includes a substrate and a structured layer having a porous structure disposed on at least a part of the substrate, wherein the structured layer includes a laminar structure of at least two layers including a first structured layer primarily in contact with the substrate and a second structured layer disposed on the first structured layer and the second structured layer has a porosity greater than the porosity of the first structured layer.

### Aspect 16

The electrode according to Aspect 15 mentioned above further includes an electrode composite layer containing an active material, disposed on the substrate, wherein the structured layer is disposed on the outer periphery of the electrode composite layer.

### Aspect 17

An electrode laminate for an electrochemical element includes the electrode of any one of Aspects 14 to 16 mentioned above and a solid electrolyte layer disposed on the electrode composite layer and the structured layer.

### Aspect 18

An electrochemical element includes the electrode of any one of Aspects 14 to 16 mentioned above.

### Aspect 19

An all solid electrochemical element includes the electrode laminate of Aspect 17 mentioned above.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A method of manufacturing an electrode for an electrochemical element comprising:
forming a structured layer including:
applying a first liquid composition containing a first polymerizable compound and a first solvent onto a substrate;
polymerizing the first liquid composition applied in the applying the first liquid composition to form a first polymerized compound layer of the first liquid composition with a porous structure; and
applying a second liquid composition containing a second polymerizable compound and a second solvent onto the first polymerized compound layer to manufacture the electrode comprising:
the substrate;
an electrode composite layer disposed on the substrate; and
the structured layer disposed on at least a part of an outer periphery of the electrode composite layer.

2. The method according to claim 1,
further comprising polymerizing the second liquid composition applied in the applying the second liquid composition to form a second polymerized compound layer of the second liquid composition.

3. The method according to claim 2,
further comprising drying the first polymerized compound layer and the second polymerized compound layer.

4. The method according to claim 1,
wherein the first polymerized compound layer has an average thickness of at least 10 μm.

5. The method according to claim 2,
wherein the second polymerized compound layer has a single-layered structure.

6. The method according to claim 2,
wherein the second polymerized compound layer has a multi-layered structure of at least two layers.

7. The method according to claim 5,
wherein at least one layer of the second polymerized compound layer has an average thickness of at least 100 μm.

8. The method according to claim 1,
wherein the first polymerizable compound is represented by the following Chemical Formula 1 or Chemical Formula 2: 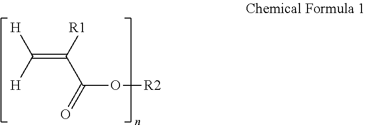
where R1 represents a hydrogen atom or a methyl group, R2 represents a hydrocarbon chain, an alkylene oxide chain, a polyester chain, or an acrylic oligomer ester derivative, and n represents an integer from 2 to 6; 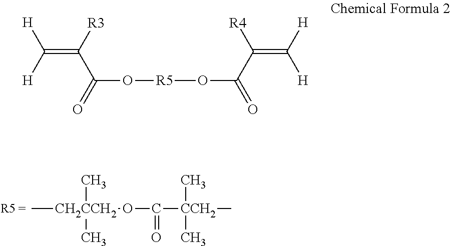
where, R3 and R4 each, independently, represent hydrogen atoms or methyl groups.

9. The method according to claim 1,
wherein the first solvent is a solvent mixture of:
a good solvent in which the first polymerizable compound is soluble; and
a poor solvent in which the first polymerizable compound is insoluble; and
the first solvent satisfies the following Relationship 1
$$Polymerizable compound soluble point \leq Mixing ratio X < Polymerizable compound soluble point + 11 \qquad Relationship 1$$
where the mixing ratio X represents a content ratio by percentage of a mass of the good solvent in the solvent mixture, and
the polymerizable compound soluble point represents a minimum content ratio by percentage of the mass of the good solvent in the solvent mixture.

10. The method according to claim 1,
wherein the first polymerizable compound is a compound mixture containing a soluble polymerizable compound soluble in the first solvent and an insoluble polymerizable compound insoluble in the first solvent, and
the first polymerizable compound satisfies the following Relationship 2,
$$Polymerizable compound soluble point \leq Mixing ratio X < Polymerizable compound soluble point + 11 \qquad Relationship 2$$
where the mixing ratio Y represents a content ratio by percentage based on a mass of the insoluble polymerizable compound in the compound mixture, and
the solvent soluble point represents a minimum content ratio by percentage based on the mass of the insoluble polymerizable compound in the compound mixture soluble in the first solvent.

11. The method according to claim 1, wherein the first solvent comprises a porogen.

12. The method according to claim 1,
wherein the first polymerized compound layer has a co-continuous structure with a resin framework.

13. The method according to claim 1,
wherein the applying the first liquid composition further comprises applying the first liquid composition onto the substrate and an outer periphery of the electrode composite layer containing an active material, and
the applying the first liquid composition and the applying the second liquid composition are carried out by inkjetting, and the electrode composite layer contains an active material.

14. An electrode for an electrochemical element comprising:
a substrate;
an electrode composite layer disposed on the substrate; and
a structured layer disposed on at least a part of an outer periphery of the electrode composite layer,
wherein the structured layer comprises a laminar structure of at least two layers including:
a first structured layer primarily in contact with the substrate; and
a second structured layer disposed on the first structured layer.

15. An electrode for an electrochemical element comprising:
a substrate; and
a structured layer having a porous structure disposed on at least a part of the substrate,
wherein the structured layer comprises a laminar structure of at least two layers including:
a first structured layer primarily in contact with the substrate and a second structured layer disposed on the first structured layer and,
the second structured layer has a porosity greater than a porosity of the first structured layer.

16. The electrode according to claim 15,
further comprising an electrode composite layer disposed on the substrate, the electrode composite layer comprising an active material,
wherein the structured layer is disposed on an outer periphery of the electrode composite layer.

17. An electrode laminate for an electrochemical element comprising:
the electrode of claim 14; and
a solid electrolyte layer disposed on the electrode composite layer and the structured layer.

18. An electrode laminate for an electrochemical element comprising:
the electrode of claim 16; and
a solid electrolyte layer disposed on the electrode composite layer and the structured layer.

19. An electrochemical element comprising:
the electrode of claim 14.

20. An electrochemical element comprising:
the electrode of claim 15.

21. An all solid state electrochemical element comprising:
the electrode laminate of claim 17.
